(19) United States
(12) Patent Application Publication
(10) Pub. No.: US 2017/0351555 A1
(43) Pub. Date: Dec. 7, 2017

(54) NETWORK ON CHIP WITH TASK QUEUES

(71) Applicant: KnuEdge, Inc., San Diego, CA (US)

(72) Inventor: Jerome Vincent Coffin, San Diego, CA (US)

(73) Assignee: KnuEdge, Inc., San Diego, CA (US)

(21) Appl. No.: 15/173,017

(22) Filed: Jun. 3, 2016

(51) Int. Cl. G06F 9/50

(52) U.S. Cl. CPC G06F 9/5083; G06F 9/5016

(57) ABSTRACT

A network on a chip architecture uses hardware queues to distribute multiple-instruction tasks to processors dedicated to performing that task. By repeatedly using the same processors to perform the same task, the frequency at which the processors access memory to retrieve instructions is reduced. If a hardware queue runs dry and a processor is remains idle, the processor will determine which queues have tasks and rededicate to performing a new task that has higher demand, without requiring the intervention of centralized load balancing software or specialized programming.

### BACKGROUND

Multi-processor computer architectures capable of parallel computing operations were originally developed for supercomputers. Today, with modern microprocessors containing multiple processor “cores,” the principles of parallel computing have become relevant to both on-chip and distributed computing environment.

### BRIEF DESCRIPTION OF DRAWINGS

For a more complete understanding of the present disclosure, reference is now made to the following description taken in conjunction with the accompanying drawings.

FIG. 1 is a block diagram conceptually illustrating an example of a multiprocessor chip with a hierarchical on-chip network architecture that includes task-assignable hardware queues.

FIGS. 2A to 2G illustrate examples of task distributors that assign tasks to hardware queues, and how the task distributors distribute task requests.

FIG. 3 illustrates an example of a packet header used to communicate within the architecture.

FIGS. 4A to 4D illustrate examples of packet payloads containing task descriptors and/or an address where a task descriptor is stored, as used within the architecture to delegate tasks.

FIG. 5 illustrates task descriptors being enqueue and dequeued from the memory/register stack of a hardware task queue.

FIG. 6 is an abstract representation of how slots within the a queue stack are accessed and recycled in a first-in-first-out (FIFO) manner.

FIG. 7 is an example circuit overview of a task-assignable hardware queue.

FIG. 8 is a block diagram conceptually illustrating example components of a processing element of the chip in FIG. 1.

FIG. 9 illustrates a plurality of the multiprocessor chips connected together, with the task-assignable queues of several of the chips assigned to receive tasks.

FIG. 10 is a transaction flow diagram illustrating an example where a processor deposits a task descriptor into an input queue, and the result is deposited into an output queue for the processor to retrieve.

FIG. 11 is a transaction flow diagram illustrating an example where a processor deposits a task descriptor into an input queue, and the result is written back directly to the processor.

FIG. 12 is a transaction flow diagram illustrating an example where a processor deposits a task descriptor into an input queue, and execution chains across queues, with the end-result being deposited into an output queue for the processor to retrieve.

FIGS. 13A to 13F illustrate examples of the content of several of the data transactions in FIG. 12.

FIG. 14 is a transaction flow diagram illustrating an example where a processor deposits a task descriptor into an input queue, and a task-assigned processor deposits a sub-task into another input queue as a subroutine, with the end-result being deposited into an output queue for the processor to retrieve.

FIG. 15 is a hybrid process-flow transaction-flow diagram illustrating execution of a scheduler program by a task-assigned processor, enabling the processor to autonomously subscribe and unsubscribe from task queues.

### DETAILED DESCRIPTION

Semiconductor chips that include multiple computer processors have increased in complexity and scope to the point that on-chip communications may benefit from a routed packet network within the semiconductor chip. By using a same packet format on-chip as well as off-chip, a seamless fabric is created for high data throughput computation that does not require data to be re-packed and re-transmitted between devices.

To facilitate such an architecture, a multi-core chip may include a top level (L1) packet router for moving data inside the chip and between chips. All data packets are preceded by a header containing routing data. Routing to internal parts of the chip may be done by fixed addressing rules. Routing to external ports may be done by comparing the packet header against a set of programmable tables and/or registers. The same hardware can route internal-to-internal packets (loopback), internal-to-external packets (outbound), external-to-internal packets (inbound) and external-to-external packets (pass through). The routing framework supports a wide variety of geometries of chip connections, and allows execution-time optimization of the fabric to adapt to changing data flows.

However, as the number of processing elements within a system increase, there are several engineering challenges that need to be addressed. Two of the challenges are minimizing the processing bottlenecks and latency delays caused by multiple processors accessing memory at a same time, and the assigning of processing threads to processing elements. Early solutions placed the burden of assigning threads to processors on the software compiler. However, as the number of processing cores in a system may vary, compiler solutions are somewhat less flexible at run-time. Runtime solutions typically use one or more processors as dispatchers, keeping track of which processing elements are busy and which are free, and sending tasks to free processors for execution. Using a runtime solution, the burden on the compiler is reduced, since the compiler need only designate which threads can be run in parallel and which threads must be run sequentially.

While runtime solutions provide better utilization of processing elements, implementation can actually exacerbate the bottlenecks created by multiple processors overloading the memory bus with read requests. Specifically, each time a processing element is assigned to a new thread by a dispatcher, the processing element must fetch (or be sent) the executable code necessary to execute the thread specified by the dispatcher. The end result is a performance trade-off between maximizing the load balance between processors and the bus and memory bottlenecks that occur as a result.

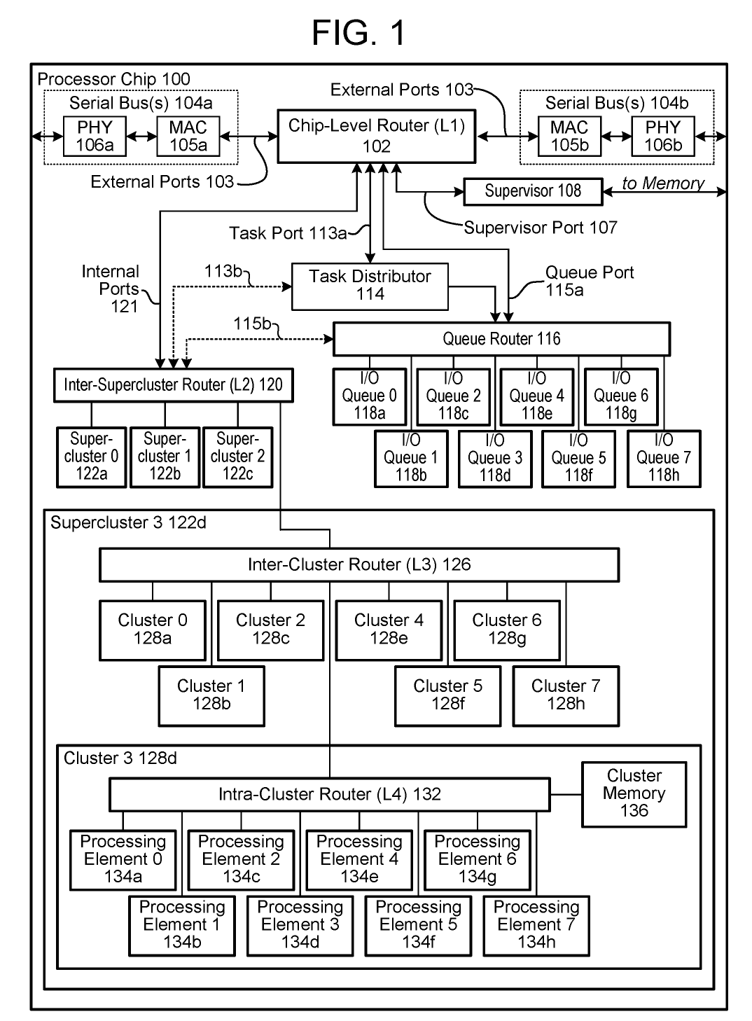

FIG. 1 is a block diagram conceptually illustrating an example of a multiprocessor chip 100 with a hierarchical on-chip network architecture that includes task-assignable hardware queues 118. The processor chip 100 may be composed of a large number of processing elements 134 (e.g., 256), connected together on the chip via a switched or routed fabric similar to what is typically seen in a computer network.

Multiple first-in-first-out (FIFO) input and output hardware queues 118 are provided on the chip 100, each of which is assignable to serve as an input queue or an output queue. When configured as an input queue, the queue 118 is associated with a single “task.” A task comprises multiple executable instructions, such as the instructions for routine, subroutine, or other complex operation.

Defined tasks are each assigned a task identifier or “tag.” When a task identifier is invoked during execution of a program by a processing element 134, a task descriptor is sent to a task distributor 114. The task descriptor includes the task identifier, any needed operands or data, and an address where the task result should be returned. The task distributor 114 identifies a nearby queue associated with one or more processing elements 134 configured to perform the task. The assigned queue may be on a same chip 100 as the processing element 134 running the software that invoked the task, or may be on another chip. Since the processing elements subscribed to input queues repeatedly perform the same tasks, they can locally store and execute the same code over-and-over, substantially reducing the communication bottlenecks created when a processing element must go and fetch code (or be sent code) for execution.

Each input queue is affiliated with at least one subscribed processing element 134. The processing elements 134 affiliated with the input queues may each be loaded with a small scheduler program that is invoked after the processing element is idle for (or longer than) a specified/preset/predetermined duration (which may vary in length in accordance with the complexity of the task of the queue to which the processing element is currently affiliated/subscribed) When the scheduler program is invoked, the processing element 134 may unsubscribe from the input queue it was servicing and subscribe to a different input queue. In this way, processing elements can self-load balance independent of any central dispatcher.

In other words, it is not up to the main software program or a central dispatcher to assign work to a particular core (or possibly even to a particular chip). Instead, the chip 100 has some queues at a top level (in the network hierarchy), with each queue supporting one type of task at any time. To get a task done, a program deposits a descriptor of the task that needs to be done with a task distributor 114, which deposits the descriptor into the appropriate queue 118. The processing elements affiliated with the queue do the work, and typically produce output to some other queue (e.g., a queue 118 configured as an output queue).

Each hardware queue 118 has at least one event flag attached, so a processor core can sleep while waiting for a task to be placed in the queue, powering down and/or de-clocking operations. After a task descriptor is enqueued, at least one of the cores affiliated with that queue is awakened by the change in state of the event flag, causing the processor core to retrieve (dequeue) the descriptor and to start processing the operands and/or data it contains, using the locally-stored executable task code.

As noted, the hardware queues 118 may be configured as input queues or output queues. Dedicated input queues and dedicated output queues may also/instead be provided. When a task is finished, the last processing element to execute a portion of the assigned task or chain of tasks may deposit the results in an output queue. These output queues can generate event flags that produce externally visible (e.g., electrical) signals, so a host processor or other hardware (e.g., logic in an FPGA) can retrieve the finished result.

In the example in FIG. 1, the processing elements 134 are arranged in a hierarchical architecture, although other arrangements may be used. In the hierarchy, each chip 100 includes four superclusters 122a-122d, each supercluster 122 comprises eight clusters 128a-128h, and each cluster 128 comprises eight processing elements 134a-134h. If each processing element 134 includes two-hundred-fifty-six externally exposed registers, then within the chip 100, each of the registers may be individually addressed with a sixteen bit address: two bits to identify the supercluster, three bits to identify the cluster, three bits to identify the processing element, and eight bits to identify the register.

Memory within a system including the processor chip 100 may also be hierarchical, and memory of different tiers may be physically different types of memory. Each processing element 134 may have a local program memory containing instructions that will be fetched by the core's micro-sequencer and loaded into the instruction registers for execution in accordance with a program counter. Processing elements 134 within a cluster 124 may also share a cluster memory 136, such as a shared memory serving a cluster 128 including eight processor cores 134a-134h. While a processor core may experience no latency (or a latency of one-or-two cycles of the clock controlling timing of the instruction pipeline) when accessing its own operand registers, accessing global addresses external to a processing element 134 may experience a larger latency due to (among other things) the physical distance between the addressed component and the processing element 134. As a result of this additional latency, the time needed for a processor core to access an external main memory, a shared cluster memory 136, and the registers of other processing elements may be greater than the time needed for a core to access its own execution registers.

Each tier in the architecture hierarchy may include a router. The top-level (L1) router 102 may have its own clock domain and be connected by a plurality of asynchronous data busses to multiple clusters of processor cores on the chip. The L1 router may also be connected to one or more external-facing ports that connect the chip to other chips, devices, components, and networks. The chip-level router (L1) 102 routes packets destined for other chips or destinations through the external ports 103 over one or more high-speed serial busses 104a, 104b. Each serial bus 104 comprises at least one media access control (MAC) port 105a, 105b and a physical layer hardware transceiver 106a, 106b.

The L1 router 102 routes packets to and from a primary general-purpose memory for the chip through a supervisor port 107 to a memory supervisor 108 that manages the general-purpose memory. Packets to-and-from lower-tier components are routed through internal ports 121.

Each of the superclusters 122a-122d may be interconnected via an inter-supercluster router (L2) 120 which routes transactions between superclusters and between a supercluster 122 and the chip-level router (L1) 102. Each supercluster 122 may include an inter-cluster router (L3) 126 which routes transactions between each cluster 128 in the supercluster 122, and between a cluster 128 and the inter-supercluster router (L2) 120. Each cluster 128 may include an intra-cluster router (L4) 132 which routes transactions between each processing element 134 in the cluster 128, and between a processing element 134 and the inter-cluster router (L3) 126. The level 4 (L4) intra-cluster router 132 may also direct packets between processing elements 134 of the cluster and a cluster memory 136. Tiers may also include cross-connects (not illustrated) to route packets between elements in a same tier in the hierarchy.

When data packets arrive in one of the routers, the router examines the header at the front of each packet to determine the destination of the packet's data payload. Each chip 100 is assigned a unique device identifier (“device ID”). Packet headers received via the external ports 103 each identify a destination chip by including the device ID in an address contained in the packet header. Packets that are received by the L1 router 102 that have a device ID matching that of the chip containing the L1 router are routed within the chip using a fixed pipeline to the supervisor 108 or through one of the internal ports 121 linked to a cluster of processor cores within the chip. When packets are received with a non-matching device ID by the L1 router 102, the L1 router 102 uses programmable routing to select an external port and relay the packet back off the chip.

When a program invokes a task, the invoking processing element 134 sends a packet comprising a task descriptor to the local task distributor 114. The L1 router 102 and/or the L2 router 120 include a task port 113a/113b and a queue port 115a/115b. The routers route the packet containing the task descriptor via the task port 113 to the task distributor 114, which examines the task identifier included in the descriptor and determines which queue 118 to which to assign the task. The assigned queue 118 may be on the chip 100, or may be a queue on another chip. If the task is to be deposited in a queue on the chip, the task distributor 114 transfers the descriptor to the queue router 116, which deposits the descriptor in the assigned queue. Otherwise, task descriptor is routed to the other chip which contains the assigned queue 118.

The queue port 115a is used by the L1 router 102 to route descriptors that have been assigned by the task distributor 114 on another chip to the designated input queue 118 via the queue router 116. When queues 118 are configured as output queues, the processing elements 134 may retrieve task results from the output queue via the queue port 115a/115b using read/get requests, routed via the L1 and/or L2 routers.

Cross-connects (not illustrated) may be provided to signal when there is data enqueued in the I/O queues, which the processing elements 134 can monitor. For example, an eight-bit bus may be provided, where each bit of the bus corresponds to one of the I/O queues 118a-118f. When a queue is configured as an output queue, a processing element 134 may monitor the bit line corresponding to the queue while awaiting task results, and retrieve the results after the bit line is asserted. When a queue is configured as an input queue, subscribed processing elements 134 may monitor the bit line corresponding to the queue for tasks for the availability of tasks awaiting processing.

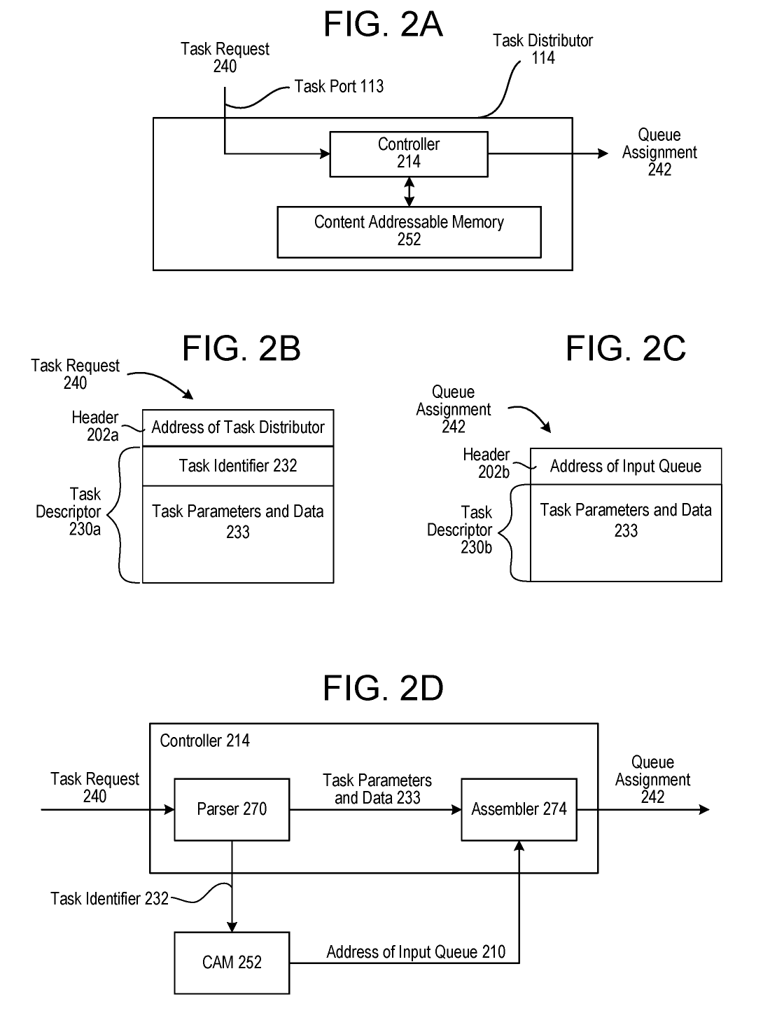

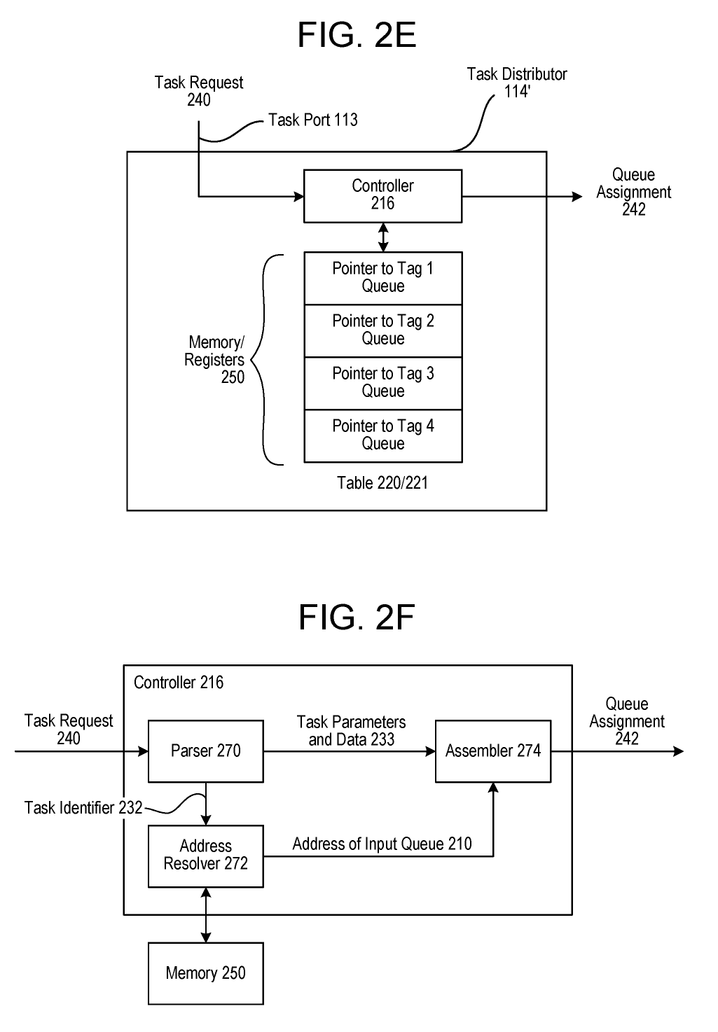

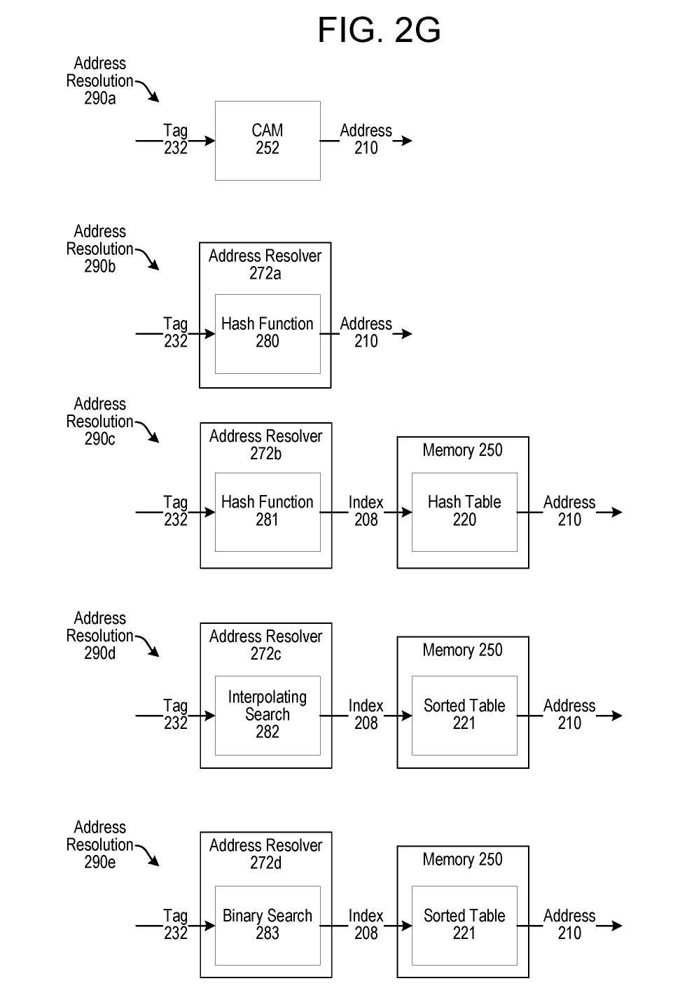

FIGS. 2A and 2E are examples task distributors 114/114′ that assign tasks to a hardware queue. In each of the examples, the task distributors 114/114′ receives a task request 240 via a task port 113, selects a task input queue 118 associated with the task based on a task identifier 232 included in the task request 240, obtains an address or other queue identifier of the task input queue 118, and enqueues the task request 240 in the queue 118 using the address or other identifier.

Selecting the task input queue and obtaining its address may be performed as plural steps or may be combined as a single step. Depending upon how the task distributor 114/114′ is implemented, a task input queue may be selected and then an address/identifier may be obtained for the selected task input queue, or the addresses/identifiers of one or more task input queues may be obtained and then the task input queue may be selected. Process combinations may also be used to select a queue and obtain a queue address/identifier, such as selecting several candidate input task queues, obtaining their addresses/identifiers, and then selecting an input task queue based on its address/identifier.

In the example in FIG. 2A, the task distributor 114 receives a task request 240 and the controller 214 of the task distributor 114 uses a content-addressable memory (CAM) 252 to select the task input queue 118 and obtain the address/identifier 210 of the input queue 118 based on the extracted task identifier 232. An advantage of using a CAM 252 over using hash tables or table look-up techniques is that a CAM can return a result typically within one or two clock cycles, which will typically be faster than hashing or searching a table. A disadvantage of CAM is that each CAM 252 takes up more physical space on the chip 100, with the amount of space needed increasing as the number of queues 118 increases. However, CAM is practical if there is a limited number of task queues (e.g., 8 input queues). Thus, there is a speed versus space trade-off between CAM and other address resolution approaches.

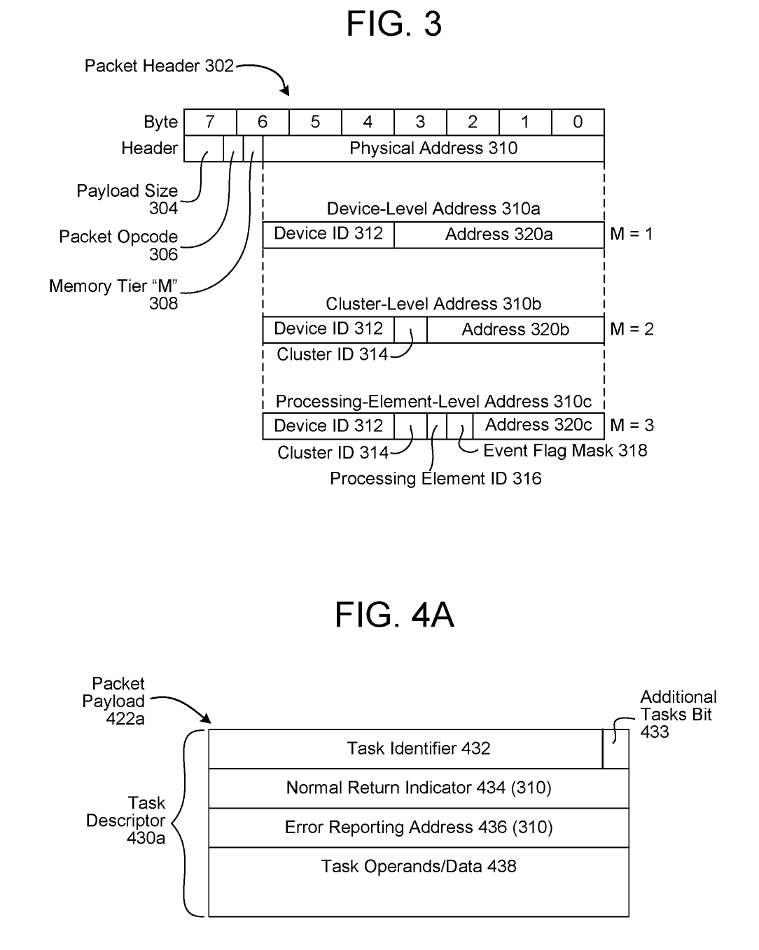

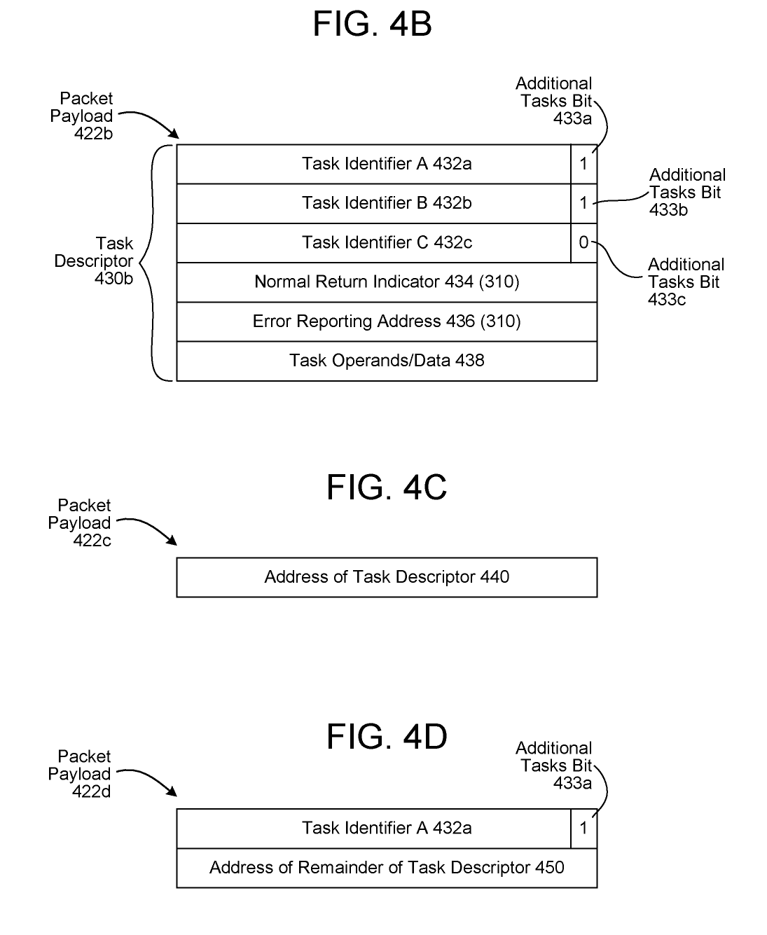

FIG. 2B illustrates an example structure of the task request packet 240, and FIG. 2C illustrates an example structure of the queue assignment packet 242. The structures of these packets will be discussed in more detail in connection with FIG. 3 and FIGS. 4A-4D below, but are introduced here to explain the operation of the task distributors 114 and 114′. Referring to FIG. 2B, the task request packet 240 includes a header 202a and a payload comprising a task descriptor 230a. The header 202a includes the address of the task distributor 114/114′. The task descriptor 230a comprises a task identifier 232 and various task parameters and data 233. Referring to FIG. 2C, the queue assignment packet 242 includes a header 202b and a payload comprising a task descriptor 230b. The task descriptor 230b comprises the task parameters and data 233.

FIG. 2D illustrates the components of the controller 214, and the principles of operation of the task distributor 114. As illustrated in FIG. 2B, the task request packet 240 has a particular format, such that a parser 270 can read/extract the specific range of bits from the packet that correspond to the task identifier 232, with the bits that follow the task identifier 232 being the task parameters and data 233. Relative to the packet payload containing the task descriptor 230a, the task identifier 232 begins at a pre-defined offset (e.g., an offset of zero as illustrated in FIG. 2B). The parser 270 outputs the bits corresponding to the task identifier 232 to the CAM 252. The bits corresponding to the task parameters and data 233 are directed to an assembler 274. The CAM 252 contains an associative array table that links search tags (i.e., the task identifiers) to input queue addresses/identifiers. The CAM 252 receives the task identifier 232 and outputs a queue address/identifier 210 of a selected input queue that is configured to receive the specified task.

The parser 270 may optionally include additional functionality. For example, it is possible to compress the task descriptor 230a (e.g., using Huffman encoding). In such a case, the parser 270 may be responsible for de-compressing any data that precedes the task identifier 232 to find the offset at which the task identifier 232 starts, then transmitting the task identifier 232 to the CAM 252. In such a design, the CAM 252 might use either the compressed or un-compressed form of the task identifier 232 as its key. In the latter case, the parser 270 would also be responsible for de-compressing the task identifier 232 prior to transmitting it to the CAM 252.

The assembler 274 is roughly a mirror image of the parser 270. Where the parser 270 extracts a task identifier 232 that indirectly refers to a task queue, the assembler 274 re-assembles an output packet (queue assignment 242) that describes the task with a header 202b that includes a physical or virtual address of a selected queue based on the address/identifier 210, where the header address is for the selected input queue that can carry out the type of task denoted by the task identifier 232. The payload of the output packet comprises the parameters and data 233. The assembler 274 receives the address/identifier 210 of the selected input queue from the CAM 252 and the task parameters and data 233 from the parser 270. Various approaches may be used by the assembler 274 to assemble the output packet 242. For example, the parser 270 may send the task descriptor 230a to the assembler, and the assembler 274 may overwrite the bits corresponding to the task identifier 232 with the header address, or the assembler 274 may concatenate the header address with the task parameters and data 233.

The assembler 274 may also include additional functionality. For example, if a compressed format is being used, the assembler 274 may re-compress some or all the task parameters and data 233 contained in the routable task descriptor 230b. The assembler 274 could also rearrange the data, or carry out other transformations such as converting a compressed format to an uncompressed format or vice versa.

In FIG. 2E, the task distributor 114′ receives the task request 240 via the task port 113. A hash table 220 or sorted table 221 may be stored in a memory or a plurality of registers 250 associated with the task distributor 114′. In the tables 220/221, types of tasks are identified by a system-wide address of a kernel used to process that type of task. A controller 216 extracts the task identifier 232 from the descriptor 230a of the task request 240, and applies a hash function or search function to select a task input queue 118, and to obtain the address 210 or other queue identifier of the task input queue 118. A hash function may be used to select the queue and obtain the queue's address/identifier 210 with or without a hash table 220. A search function may be used to select the queue and obtain the queue's address/identifier 210 based on data in a sorted table 221.

In the case of a large system, the hash table 220 may be a distributed hash table, so one type of task has queues distributed throughout the system. A task request 240 causes the controller 216 to apply a distributed hash function to produce a hash that would find a “nearby” queue for that task, where the nearby queue should be reachable with a latency from the task identifier that is less than (or tied for smallest) that to reach other queues associated with the same task. Expected latency may be determined, among other ways, based on the minimum number of “hops” (e.g., intervening routers) to reach each queue from the task distributor 114′. The controller 216 outputs a packet containing the queue assignment 242, replacing the destination address in the header with the address of the assigned queue, as discussed in connection with FIGS. 2A-2D. The packet is then routed to the assigned queue where it is enqueued, either via the queue router 116 or the L1 router 102 (if the queue is on another chip).

“Hop” information be determined, among other ways, from a routing table. The routing table may, for example, be used to allocate addresses that indicate locality to at least some degree. Distributed hashing frequently uses a very large (and very sparse) address space “overlaid” on top of a more typical addressing scheme like Internet Protocol (IP). For example, a hash might produce a 160-bit “address” that's later transformed to a 32-bit IPv4 address. With a logical address space like this, the allocation of addresses maybe be tailored to the system topology, such that the address itself provides an indication of that node's locality (e.g., assuming a backbone plus branches, the address could directly indicate a node's position on the backbone and distance from the backbone on its branch).

Hop information can be used with the CAM 252 as well. However, given the expense of storage in a CAM and the advantageous of keeping that data to a minimum, each CAM 252 will ordinarily store just one “best” result for a given tag lookup.

FIG. 2F illustrates the components of the controller 216, and the principles of operation of the task distributor 114′. The parser 270 and the assembler 274 are the same as those discussed in connection with FIG. 2D. However, in controller 216, the parser 270 outputs the task identifier 232 to an address resolver 272. The address resolver 272 applies a hash or search function to select the queue and obtain the queue's address/identifier 210, outputting the address/identifier 210 to the assembler 274.

FIG. 2G illustrates examples of different process flows that may be used by the controller 214/216 for address resolution (290a-290e). Resolution process 290a corresponds to that used by the task distributor 114 in FIGS. 2A and 2D, with a task identifier (tag 232) input into the CAM 252, producing the queue address/identifier 210.

Resolution process 290b may be used by an address resolver 272a (an example of address resolver 272 in FIG. 2F) without a table 220/221. The address resolver 272a inputs the tag 232 into a hash function 280 as the function's “key,” where the hash function 280 hashes the key to produce the queue address/identifier 210. In comparison to resolution process 290b, resolution processes 290c adds an address lookup to resolve the hash into an address or other identifier. An address resolver 272b (an example of address resolver 272 in FIG. 2F) uses a hash table 220 to lookup the address/identifier 210. The tag 232 is input into the hash function 281 as functions “key,” where the hash function 281 hashes the key to produce one or more index values 208. The address resolver 272b resolves the index value 208 into the address/identifier 210 using the hash table 220. If there is more than one tag 232 that hashes to the same table location, the result is a hash “collision.” Such collisions can be resolved in any of several ways, such as linear probing, collision chaining, secondary hashing, etc.

Since the number of nodes/chips 100 in a system may vary dynamically, when a node is added or removed, a distributed hash function (e.g., 280, 281) may be recomputed and redistributed to all the task distributors 114′. Other options include leaving the function 280/281 itself, but modifying data that it uses internally (not illustrated, but may also be stored in registers/memory 250), or leave the function 280/281 alone, but modify the address lookup data (e.g., hash table 220). Choosing between modifying the hash function's data and modifying the lookup data is often a fairly open choice, and depends in part on how the hash function is structured and implemented (e.g., implemented in hardware, implemented as processor-executed software, etc.).

To optimize results for locality within the system, it is advantageous to produce a final address result that is based on location (relative to the topology of interconnected devices 100). The hash functions 280/281 used by the task distributors 114′ may the same throughout the system, or may be localized, depending upon whether localization data is updated by updating the hash function 280/281, its internal data, or its lookup table 220. For example, the distributed hash tables 220, sorted tables 221, and/or data used by the functions stored in one or more registers may be updated each time a device/node 100 is added or removed from the system.

As an alternative to a hash function, a lookup table may be used to store a tag 232, and with it an address/queue identifier 210. Sorting the table by tag 232, an interpolating search 282 may be used to search a small table, or a binary search 283 search may be used to sort a large table. Resolution processes 290d may be used by an address resolver 272c (an example of address resolver 272 in FIG. 2F) with a sorted table 221. The address resolver 272c performs an interpolating search 282 on the sorted table 221, using an index 208 based on the tag 232. The search 282 produces the address/identifier 210. Resolution processes 290e may be used by an address resolver 272d (an example of address resolver 272 in FIG. 2F) with the sorted table 221. The address resolver 272d performs a binary search 283 on the sorted table 221, using the index 208 based on the tag 232. The search 283 produces the address/identifier 210. Other search methods may be used. Also, while the table 221 is sorted for efficiency, a non-sorted table may instead be used, depending upon the search method employed.

If the hash function 280/281 or search function 282/283 is implemented in hardware, the logic providing the function 280-283 may fixed, with updates being to table values (e.g., 220/221) and/or to other registers storing values used by the function, separate from the logic. If the function is implemented as processor-executed software, either the software (as stored in memory) may be updated, table values (e.g., 220/221) may be updated, and/or registers storing values used by the function may be updated. Also, the type of function and nature of the tables may be changed as the system scales, selecting a function 280-283 optimized for the scale of the topology.

Choosing between address resolution techniques depends pretty factors that are not relevant to the task queues 118 themselves, and are fairly well known in the art. Hash tables 220 typically have O(1) expected complexity, but O(N) worst case (but deletion is often more expensive, and sometimes completely unsupported). Sorted tables 221 with binary search 283 offers O(log N) lookup, and O(N) insertion or deletion. Sorted tables 212 with interpolating search 282 improves search complexity to O(log log N), but insertion or deletion is still typically O(N). A self-balanced binary search tree may be used for O(log N) insertion, deletion or lookup. In a small system, all of the table-based address resolution approaches should be adequate, as the tables involved are relatively small.

Each time the data and/or functions used by the controllers 214/216 is updated, one-or-more processing elements 134 on the chip 100 may load and launch a queue update program. In conjunction with the task distributor 114/114′, the queue update program may determine the input queue address/identifier 210 for each possible task ID 232, and determine whether any of those addresses/identifiers are for I/O queues 118 on the device 100 containing the task distributor 114/114′. The queue update program then configures each queue for the assigned task (if not already configured), and configures at least one processing element 134 to subscribe to each input queue.

FIG. 3 illustrates an example of a packet header 302 used to communicate within the architecture. A processing element 134 may access its own registers directly without a global address or use of packets. For example, if each processor core has 256 operand registers, the core may access each register via the register's 8-bit unique identifier. Likewise, a processing element can directly access its own program memory. In comparison, a global address may be (for example) 64 bits. Shared memory and the externally accessible locations in the memory and registers of other processing elements may be addressed using a global address of the location, which may include that address' local identifier and the identifier of the tier (e.g., device ID 312, cluster ID 314).

As illustrated in FIG. 3, a packet header 302 may include a global address. A payload size 304 may indicate a size of the payload associated with the header. If no payload is included, the payload size 304 may be zero. A packet opcode 306 may indicate the type of transaction conveyed by the header 302, such as indicating a write instruction, a read instruction, or a task assignment. A memory tier “M” 308 may indicate what tier of device memory is being addressed, such as main memory (connected to memory supervisor 108), cluster memory 136, or a program memory or registers within a processing element 134.

The structure of the physical address 310 in the packet header 302 may vary based on the tier of memory being addressed. For example, at a top tier (e.g., M=1), a device-level address 310a may include a unique device identifier 312 identifying the processor chip 100 and an address 320a corresponding to a location in main-memory. At a next tier (e.g., M=2), a cluster-level address 310b may include the device identifier 312, a cluster identifier 314 (identifying both the supercluster 122 and cluster 128), and an address 320b corresponding to a location in cluster memory 136. At the processing element level (e.g., M=3), a processing-element-level address 310c may include the device identifier 312, the cluster identifier 314, a processing element identifier 316, an event flag mask 318, and an address 320c of the specific location in the processing element's operand registers, program memory, etc. Global addressing may accommodate both physical and virtual addresses.

The event flag mask 318 may be used by a packet to set an “event” flag upon arrival at its destination. Special purpose registers within the execution registers of each processing element may include one or more event flag registers, which may be used to indicate when specific data transactions have occurred. So, for example, a packet header designating an operand register of a processing element 134 may indicate to set an event flag upon arrival at the destination processing element. A single event flag but may be associated with all the registers, or with a group of registers. Each processing element 134 may have multiple event flag bits that may be altered in such a manner. Which flag is triggered may be configured by software, with the flag to be triggered designated within the arriving packet. A packet may also write to an operand register without setting an event flag, if the packet event flag mask 318 does not indicate to change an event flag bit.

FIGS. 4A to 4D illustrate examples of packet payloads containing task descriptors, used within the architecture to delegate tasks. In FIG. 4A, a packet payload contains a task descriptor 430a. The task descriptor 430a includes the task identifier 432, a normal return indicator 434 indicating where to deposit (i.e., write/save/store/enqueue) a normal response, an address 436 where to report an error, and any task operands and data 438 (or an address of where operands and data are stored). The task descriptor 430a may also include an bit 433 that indicates whether the task descriptor 430a includes additional task identifiers 432. The additional task bit 433 may be appended onto the task identifier 432, or indicated elsewhere in the task descriptor.

The normal return indicator 434 and error reporting address 436 may indicate a memory or register address, the address of an output queue, or the address of any reachable component within the system. “Returning” results data to a location specified by the normal return indicator 434 includes causing the results data to be written, saved, stored, and/or enqueued to the location.

FIG. 4B illustrates an example of a packet payload 422b including a task descriptor 430b that contains multiple task assignments. The descriptor includes a first task identifier 432a, a second task identifier 432b, a third task identifier 432c, the normal return indicator 434, the error reporting address 436, and the task operands and data 438.

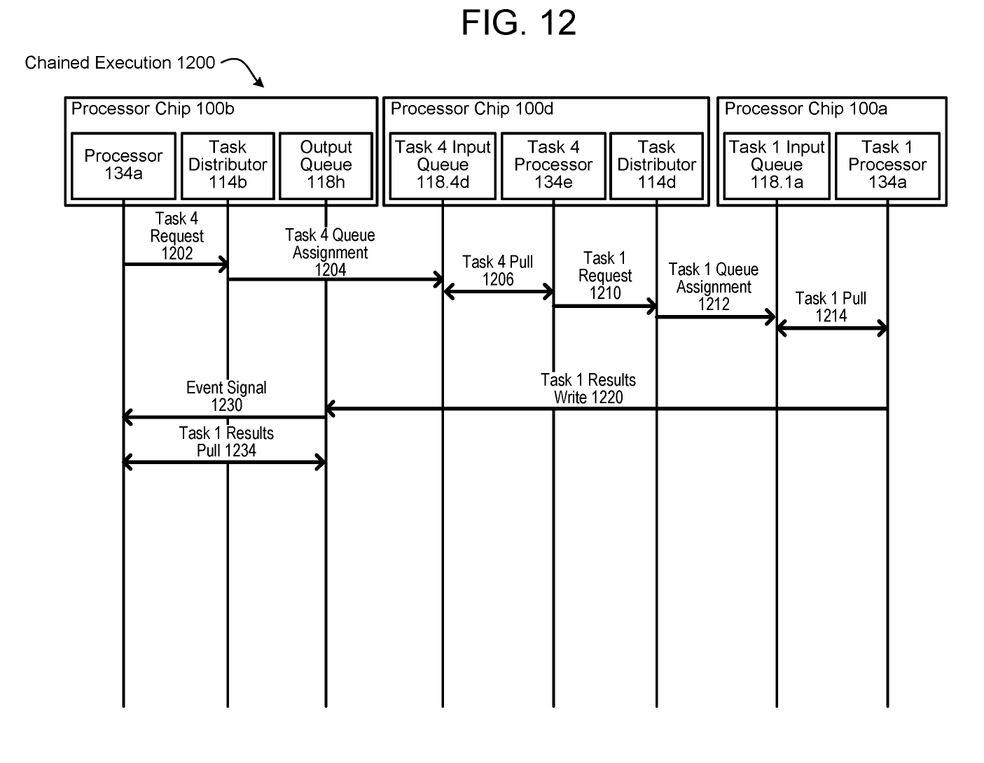

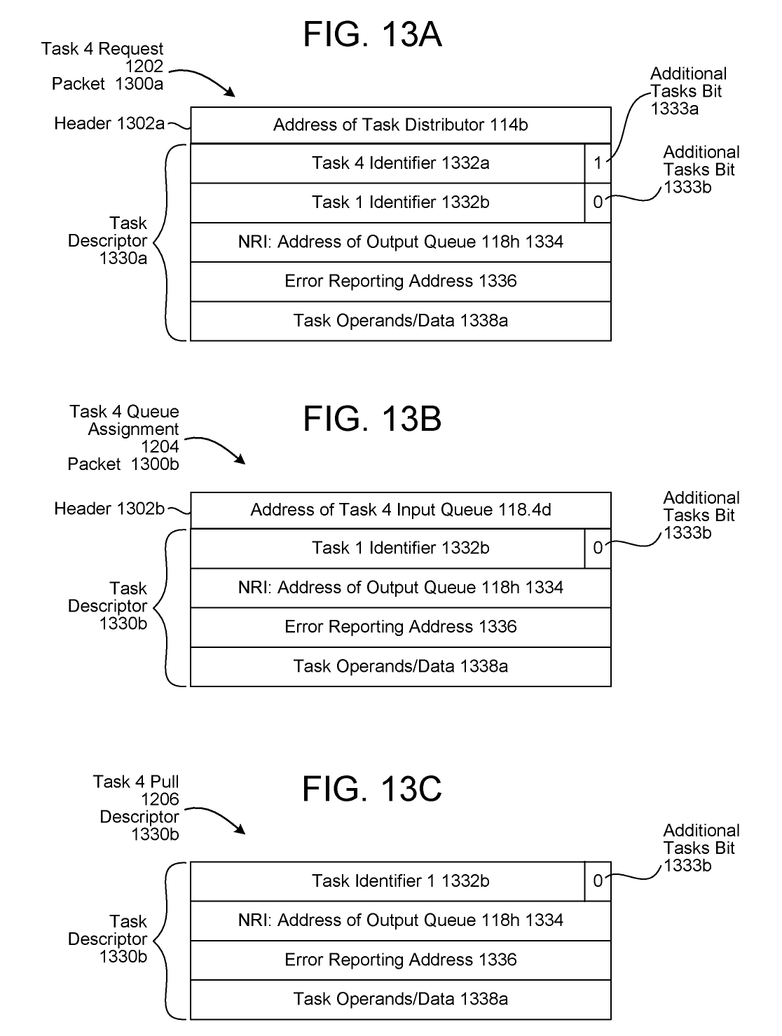

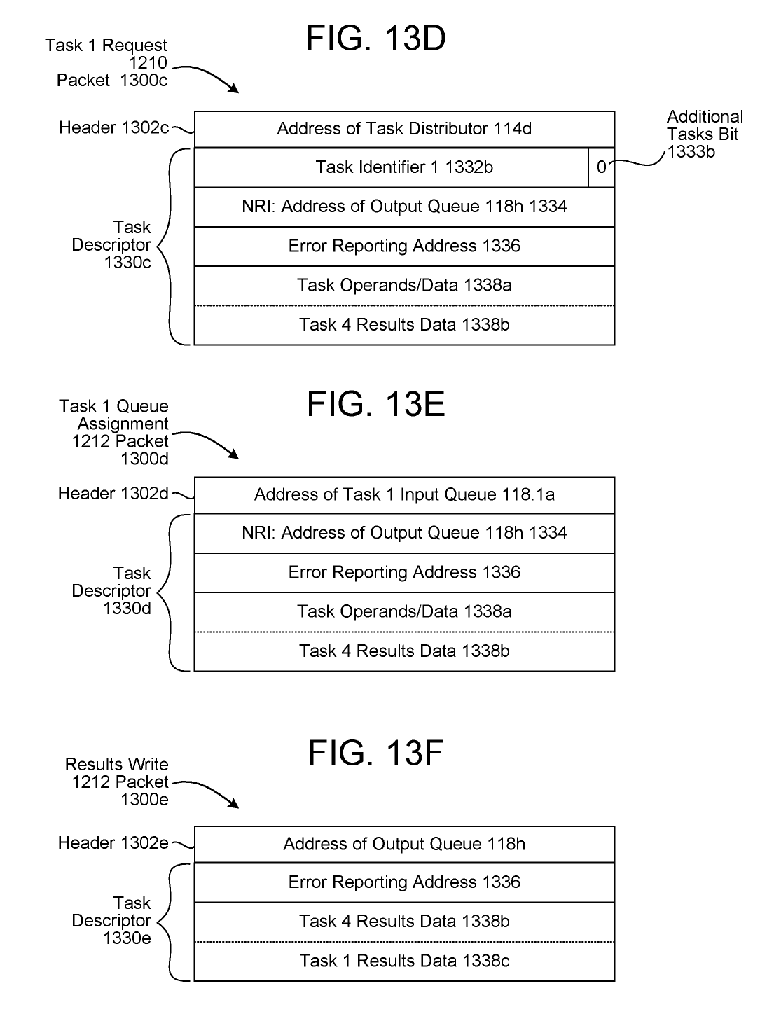

An additional task bit 433a is appended onto the first task identifier 432a, and indicates that there are additional tasks after the first task. An additional task bit 433b is appended onto the second task identifier 432b, and indicates that there are additional tasks after the second task. An additional task bit 433c is appended onto the third task identifier 432c, and indicates that there are no further tasks after the third task. The use of task chaining using the task descriptor format 430b will be discussed further below in connection with FIGS. 12 and 13A to 13F.

FIG. 4C illustrates a packet payload 422c that comprises an address 440 in memory from which the task descriptor 430 may be fetched. The stored task descriptor may be, for example, the task descriptors 430a or 430b. The originating processor stores the task descriptor prior to sending the packet carrying the memory address 440 of the task descriptor in its payload 422c. By sending only the memory address of the task descriptor 440, the size of task requests 240 and queue assignments 242 are reduced, such that the capacity of each slot in the queues 118 to be smaller. For example, using the payload 422c, the size of each slot in the queues 118 may be a single word. A “word” is a fixed-sized piece of data, such as a quantity of data handled as a unit by the instruction set and/or the processor core of a processing element 134, and can vary from core to core. For example, a “word” might be 64 bits in one architecture, whereas a “word” might be 128 bits on another architecture. A trade-off is that the task distributor 114 and a processing element 134 subscribed to an input queue must access memory to retrieve some or all of the descriptor. For example, the task distributor 114 may read the first word of the stored descriptor to determine the task identifier 432, whereas a subscribed processing element 134 may retrieve the entire stored descriptor. In an arrangement where a chained-task descriptor 430b is stored, each processing element 134 that works with the descriptor 430b (as stored in memory at address 440) may adjust an offset of the address 440 or otherwise crop the task descriptor 430b so that the identifiers of tasks that have already been completed are not retrieved again in subsequent operations.

FIG. 4D illustrates a packet payload 422d that comprises a task identifier 432a and an address 450 in memory from which a remainder of the task descriptor 430 may be fetched. While the packet payload 422d doubles the size of the payload relative to payload 422c, including the next task identifier within the packet itself simplifies the processing to be performed by the task distributor 114, since the task distributor can issue the queue assignment 242 without having to access memory to determine the next task identifier 432a. After a task-executing processing element 134 dequeues the packet and accesses remainder of the task descriptor 450 in memory, the task-executing processing element 134 can extract any subsequent task identifier (e.g., 432b) and expose the subsequent task identifier in the same manner as illustrated in FIG. 4D, when sending the subsequent task to another task distributor 114.

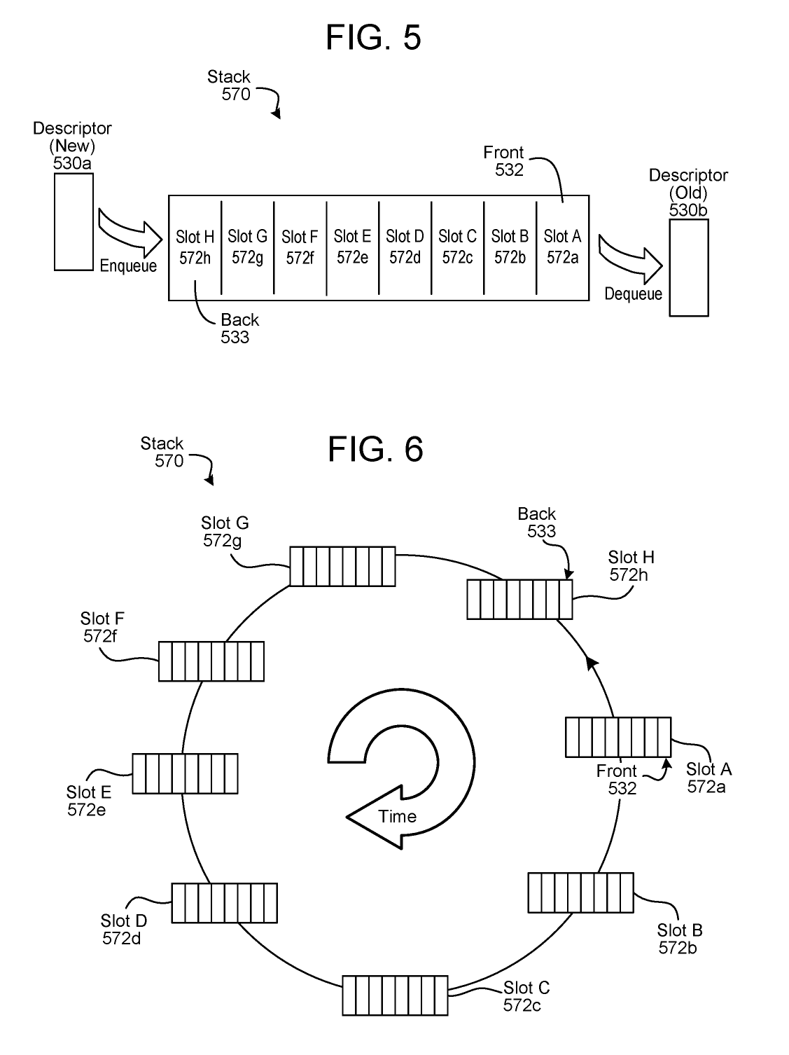

FIG. 5 illustrates task descriptors being enqueue and dequeued from the memory/register stack of a hardware task queue 118. Each queue 118 comprises a stack of storage slots 572a to 572h, where each “slot” comprises a plurality of registers or memory locations. The size of each slot may correspond, for example, to a maximum allowed size for a descriptor 430 (e.g., the maximum number of words). When an input queue receives a new descriptor 530a, it is enqueued to the back in accordance with a back pointer 533. When a subscribed processing element dequeues a descriptor 530b, the descriptor is 430b is dequeued from the front of the queue in accordance with a front pointer 532. When the queue is empty, the front pointer 532 and the back pointer 533 may be equal.

FIG. 6 is an abstract representation of how slots within the a queue stack are accessed and recycled in a first-in-first-out (FIFO) manner. Enqueued descriptors remain in their assigned slot 572, with the back pointer 533 and front pointer 532 changing as descriptors 430/530 are enqueued and dequeued.

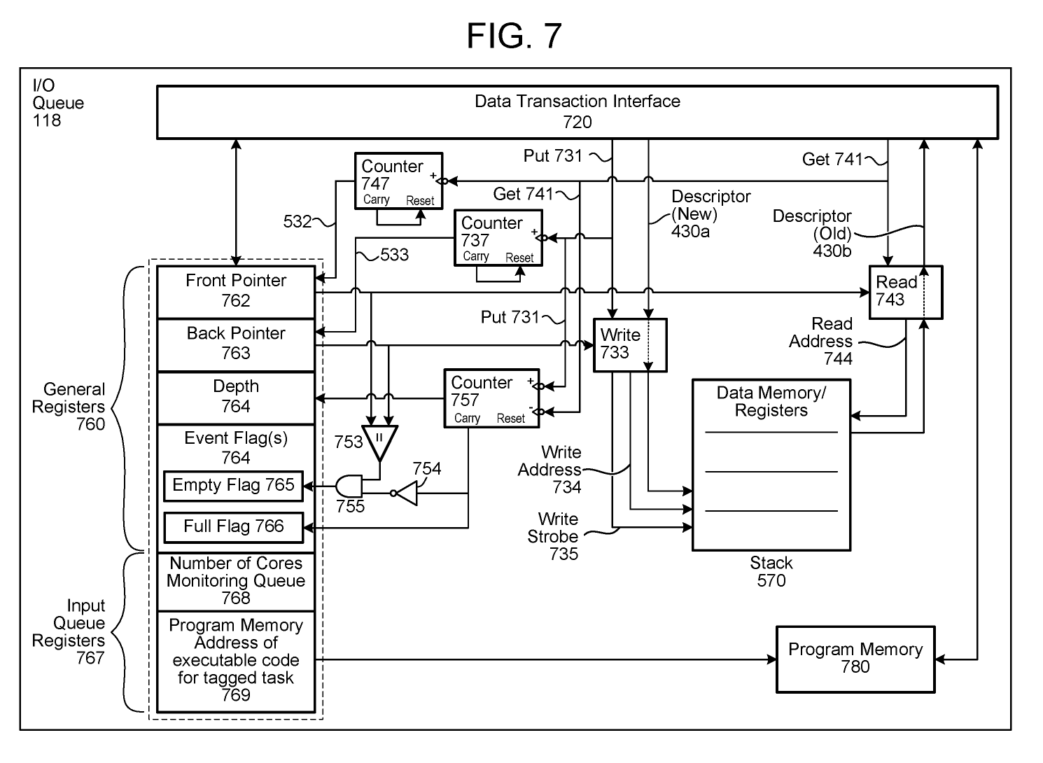

FIG. 7 is an example circuit overview of a task-assignable hardware queue 118. The queue 118 includes several general registers 760 that are used for both input queue and output queue operations. Also included are input queue-specific registers 767 that are used specifically for input queue operations.

The general purpose registers 760 include a front pointer register 762 containing the front pointer 532, a back pointer register 763 containing the back pointer 533, a depth register 764 containing the current depth of the queue, and several event flag register 764. Among the event flag registers is an empty flag 765, indicating that the queue is empty. When the empty flag 765 is de-asserted, indicating that there is at least one descriptor enqueued in the queue 118, a data-enqueued interrupt signal may be sent to subscribed processors (input queue) or a processor awaiting results (output queue), signaling them to wake and dequeue a descriptor or result. The data-enqueued interrupt signal can be generated by an inverter (not illustrated) that has its input tied to the output of the AND gate 755 or to the empty flag 765. Another event flag 764 is the full flag 766. When the full flag 766 is asserted, the data transaction interface 720 can output a back-pressure signal to the queue router 116. Assertion of a back-pressure signal may result in error reporting (in accordance with the error reporting address 436) if a task arrives for a full queue. The queue router 116 may also include an arbiter to reassign the descriptor received for the full queue to another input queue attached the queue router 116 that is configured to perform a same task (if such a queue exists).

If configured as an output queue, the event flags 764 may be masked so that when results data is enqueued, an interrupt is generated indicating to a waiting (or sleeping) processing element 134 that a result has arrived. Likewise, processing elements subscribed to an input queue can set a mask so that a data-enqueued signal from the subscribed queued causes an interrupt, but data-enqueued signals from other queues are ignored. Instead of an “empty” flag register 765, a “data available” flag register may be used, replacing the AND gate 755 with a NAND gate. In that case, data-enqueued interrupt signal can be generated in accordance with the output of the NAND gate, or the state of the data available flag register.

The input queue registers 767 are used by processing elements to subscribe and unsubscribe to the queue. A register 768 indicates how many processing elements 134 are subscribed to the queue. Each queue always has at least one subscribed processing element, so if an idle processing elements goes to unsubscribe, but it is the only subscribed processing element, then the processing element remains subscribed. When new processing elements subscribe to the queue, the number in the register 768 is incremented. Also, when a new processing element subscribes to a queue, it determines the start address where the executable instructions for the task are in memory (e.g., 780) from a program memory address register 769. The newly subscribed processing element then loads the task program into its own program memory.

When a descriptor 430 or the address 440/450 of a descriptor is received by the queue 118 for enqueuing, a data transaction interface 720 asserts a put signal 731, causing a write circuit 733 to save/store the descriptor 430 or address 440/450 into the stack 570 at a write address 734 determined based on the back pointer 533. For example, the back point 533 may specify the most significant bits corresponding to the slot 572 where the descriptor 430 is to be stored. The write circuit 733 may write (i.e., save/store) an entirety of a descriptor 430 as a parallel write operation, or may write the descriptor in a series of operations (e.g., one word at a time), toggling a write strobe 735 and incrementing the least significant bits of the write address 734 until an entirety of the descriptor 430 is stored.

After the descriptor 430 or descriptor address 440/450 is stored, the data transaction interface 720 de-asserts the put signal 731, causing a counter 737 to increment the back pointer on the falling edge of the put signal 731 and causing a counter 757 to increase the depth value. The counter 737 counts up in a loop, with the maximum count equaling the number of slots 572 in the stack 570. When the count exceeds the maximum count, a carry signal may be used to reset the counter 737, such that the counter 737 operates in a continual loop.

When a descriptor 430 is to be dequeued by a subscribing processing element 134, the data transaction interface 720 asserts a get signal 741, causing a read circuit 743 to read the descriptor 430 or descriptor address 530 from the stack at a read address 744 determined based on the front pointer 532. For example, the front point 532 may specify the most significant bits corresponding to the slot 572 where the descriptor 430b is to be stored. The read circuit 743 may read an entirety of the descriptor 430 as a parallel read operation, or may read the descriptor 430 as a series of reads (e.g., one word at a time).

After the descriptor 430 or descriptor address 440/450 is dequeued, the data transaction interface 720 de-asserts the get signal 741, causing a counter 747 to increment the front pointer 532 on the falling edge of the get signal 741 and causing a counter 757 to decrease the depth value. The counter 747 counts up in a loop, with the maximum count equaling the number of slots 572. When the count exceeds the maximum count, a carry signal may be used to reset the counter 747, such that the counter 747 operates in a continual loop.

The empty flag 765 may be set by circuit composed of a comparator 753, an inverter 754, and an AND gate 755. The comparator 753 determines when the front pointer 532 equals the back pointer 533. The inverter 754 receives the queue-full signal as input. The AND gate 755 receives the outputs of the comparator 753 and the inverter 754. When the front and back pointers are equal and the full signal is not asserted, the output of the AND gate 755 is asserted, indicating that the queue is empty. Depending upon how the counters 737, 747, 757 manage their output while asserting their “carry” signals, it may be possible for the front and back pointers to be equal when the queue is full. The inverter 754 and AND gate 755 provide for that eventuality, so that when the front and back pointers are equal and the full signal is also asserted, the output of the AND gate 755 is de-asserted, indicating that the queue is not empty. As an alternative to determine when the queue is empty, a comparator may compare the depth 764 to zero to determine when the depth equals zero. The full flag 766 may be set by the carry output of the counter 757, or a comparator may compare the depth 764 to the depth value corresponding to full.

Although the queue 118 uses a write-and-then-increment the back pointer, read-and-then-increment the front pointer arrangement, the queue may instead use an increment-and-then-write and increment-and-then-read arrangement. In that case, the counter 737 increments on the leading edge of the put signal 731, and the counter 747 increments on the leading edge of the get signal 741.

Also, instead of having both the counters 737 and 747 increment on the falling edge or increment on the leading edge, one may increment on the falling edge while the other increments on the leading edge. For example, the front pointer 532 may be incremented on the falling edge of the get signal 741, such that the front pointer 532 points to the slot that is currently at the front of the queue, whereas the back pointer 533 may be incremented on the leading edge of the put signal 731, such that the back pointer is 533 is pointing to one slot behind where the slot that will be used for the next write. In such an arrangement, when the stack 570 is empty, the front pointer and back pointer will not be equal. As a consequence, a comparison of the front and back pointers by comparator 753 will not indicate whether the stack 570 is empty. In that case, whether the stack 570 is or is not empty may be determined from the depth 764 (e.g., comparing the depth value to zero).

Whether the counter 757 increments and decrements the depth on the falling or leading edges may be independent of the arrangement used by the counters 737 and 747. If the counter 757 increments and decrements on the leading put/get signal edges, subscribed or monitoring processing elements 134 may begin to dequeue a descriptor or descriptor address while it is being enqueued, since the data-enqueued interrupt signal may be generated be generated before enqueuing is complete, thereby accelerating the enqueuing and dequeuing process. To accommodate simultaneous enqueuing and dequeuing from a same slot of the stack 570, the memory/registers used for the stack 570 may be dual-ported. Dual-ported memory cells/registers can be read via one port and written to via another port at a same time. In comparison, if the counter 757 increments and decrements on the falling put/get signal edges (as illustrated in FIG. 7), then the descriptor or descriptor address will be fully loaded into the slot 572 before the data-enqueued interrupt signal is asserted.

The front pointer 532, the back pointer 533, the depth value, empty flag, and full flag are illustrated in FIG. 7 as being stored in general registers 760. Using such registers, looping increment and decrement circuits may be used to update the front pointer 532, back pointer 533, and depth value as stored in their registers instead of using dedicated counters. In the alternative, using the counters 737/747/757, the general registers 760 used to store the front pointer 502, back pointer 503, depth value, empty flag, and full flag may be omitted, with the values read from the counters and logic (e.g., logic 753, 754, 755). Also, if any two of the front pointer 532, back pointer 533, and the depth value are known, the third value can be determined. So, for example, the depth can be determined based on the difference between the front pointer and the back pointer, or the depth can be used to determine the value of the front or back pointer, based on the value of the other pointer.

Although FIGS. 5 through 7 illustrate the FIFO queues as circular queues, other queue styles may be used such as FIFO shift register queues. A shift register queue comprises a series of registers, where each time a slot is dequeued, all of the contents are copied forward. With shift register queues, the slot constituting the “front” is always the same, with only the back pointer changing. However, circular queues have advantages over shift register queues, such as lower power consumption, since copying multiple descriptors or descriptor addresses from slot-to-slot each time a descriptor 430 or descriptor address 440/450 is dequeued increases power consumption relative to the operations of a circular queue.

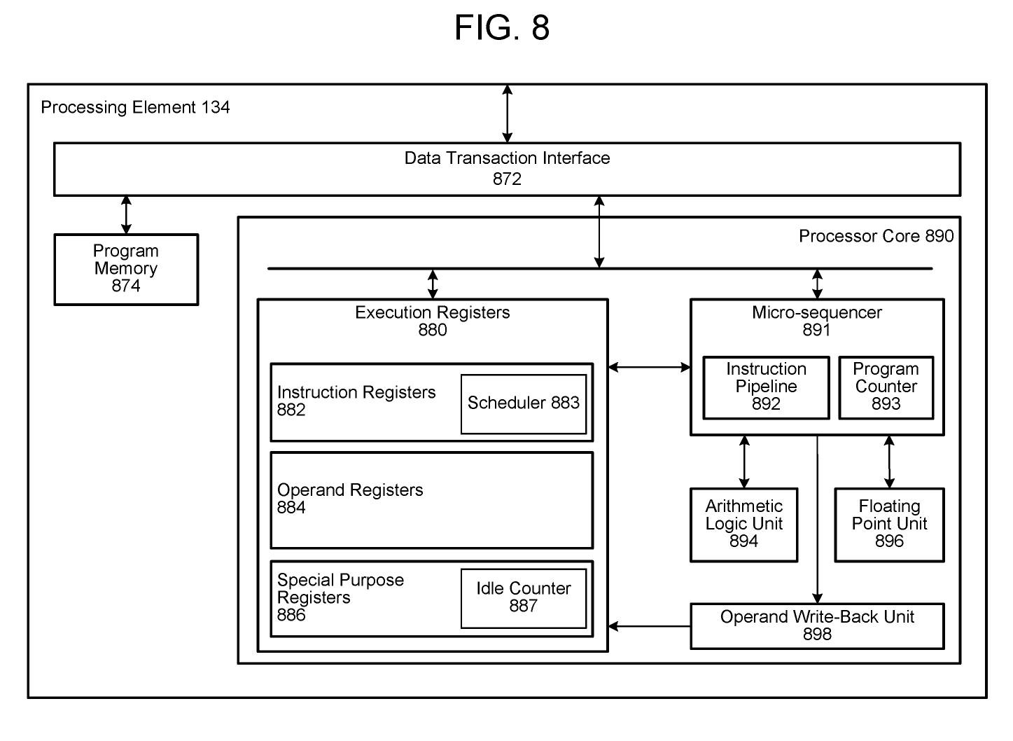

FIG. 8 is a block diagram conceptually illustrating example components of a processing element of the chip in FIG. 1. In terms of hardware, the structure of the processing elements 134 that are executing the main software program and that are subscribed to individual task queues may be identical, with the difference being that a processing element that is subscribed to a task queue 118 is loaded/configured with the scheduler 883 and idle counter 887.

A data transaction interface 872 sends and receives packets and connects the processor core 890 to its associated program memory 874. The processor core 890 may be of a conventional “pipelined” design, and may be coupled to sub-processors such as an arithmetic logic unit 894 and a floating point unit 896. The processor core 890 includes a plurality of execution registers 880 that are used by the core 890 to perform operations. The registers 880 may include, for example, instruction registers 882, operand registers 884, and various special purpose registers 886. These registers 880 are ordinarily for the exclusive use of the core 890 for the execution of operations. Instructions and data are loaded into the execution registers 880 to “feed” an instruction pipeline 892. While a processor core 890 may experience no latency (or a latency of one-or-two cycles of the clock controlling timing of a micro-sequencer 891) when accessing its own execution registers 880, accessing memory that is external to the core 890 may produce a larger latency due to (among other things) the physical distance between the core 890 and the memory.

The instruction registers 882 store instructions loaded into the core that are being/will be executed by an instruction pipeline 892. The operand registers 884 store data that has been loaded into the core 890 that is to be processed by an executed instruction. The operand registers 884 also receive the results of operations executed by the core 890 via an operand write-back unit 898. The special purpose registers 886 may be used for various “administrative” functions, such as being set to indicate divide-by-zero errors, to increment or decrement transaction counters, to indicate core interrupt “events,” etc.

The instruction fetch circuitry of a micro-sequencer 891 fetches a stream of instructions for execution by the instruction pipeline 892 in accordance with an address generated by a program counter 893. The micro-sequencer 891 may, for example, may fetch an instruction every “clock” cycle, where the clock is a signal that controls the timing of operations by the micro-sequencer 891 and the instruction pipeline 892. The instruction pipeline 892 comprises a plurality of “stages,” such as an instruction decode stage, an operand fetch stage, an instruction execute stage, and an operand write-back stage. Each stage corresponds to circuitry.

The chips' firmware may include a small scheduler program 883 in firmware. When a core 890 waits too long (an exact duration may be specified in a register, e.g., based on a number of clock cycles) for a task to show up in its queue, the core 890 wakes up and runs the scheduler 883 to find some other queue with tasks for it to execute, and thereafter begins executing those tasks. The scheduler program 883 may be loaded into the instruction registers 882 of processing elements 134 subscribed to a task queue when the processing element's idle counter 887 indicates at that the threshold duration of time has transpired (e.g., that the requisite number of clock cycles have elapsed). The scheduler program 883 may either be preloaded into the processing element 134, or loaded upon expiration of the idle counter 887. The idle counter 887 causes generation of an interrupt resulting in the micro-sequencer 891 executing the scheduler 883, causing the processing element 134 to search through the (currently in-use) queues, and find a queue with tasks that need execution. Once it finds a new queue, it unsubscribes from the old queue (decrementing the number in register 768), subscribes to the new queue (incrementing the number in register 768), fetches the program address from register 769 of the new queue, and loads the task program code into its own program memory 874.

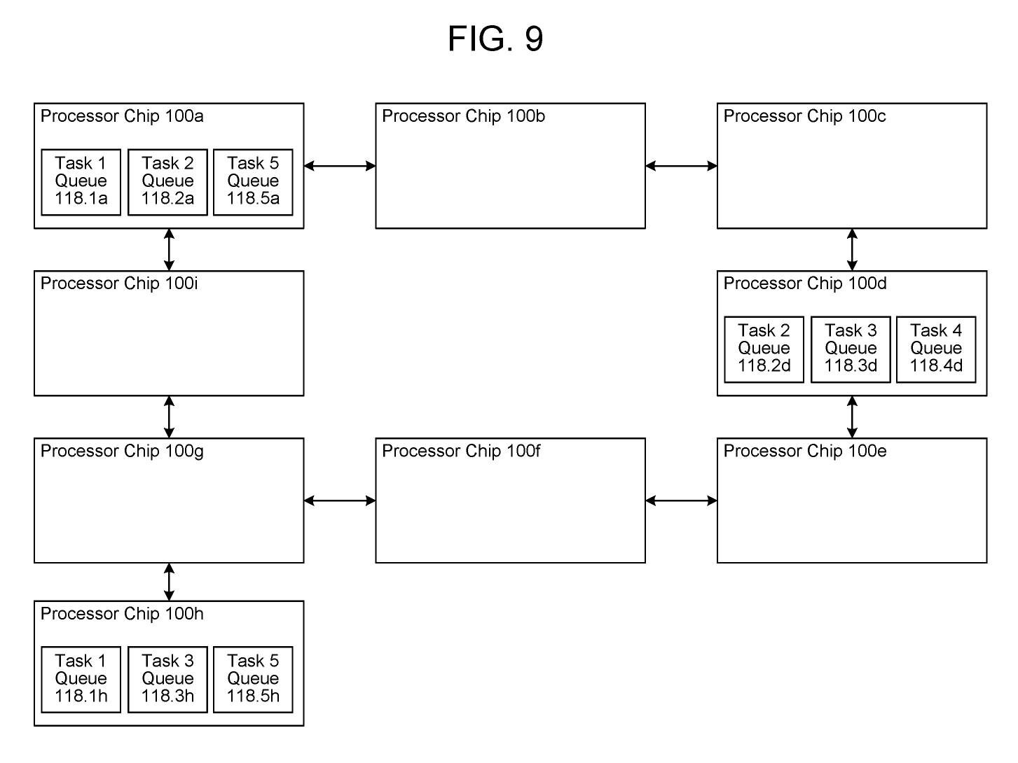

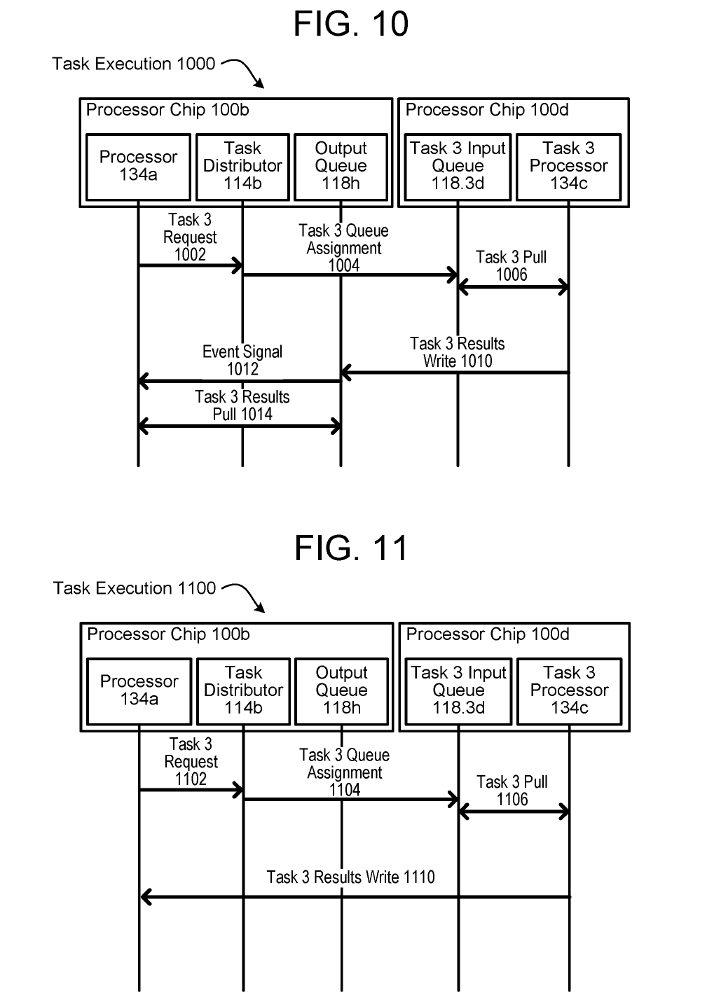

FIG. 9 illustrates a plurality of the multiprocessor chips connected together, with the task-assignable queues of several of the chips assigned to receive tasks. A processor chip 100a includes a Task 1 queue 118.1a, a Task 2 queue 118.2a, and a Task 3 queue 118.5a. A processor chip 100d includes a Task 2 queue 118.2d, a Task 3 queue 118.3d, and a Task 4 queue 118.4d. A processor chip 100a includes a Task 1 queue 118.1a, a Task 2 queue 118.2a, and a Task 3 queue 118.5a. A processor chip 100h includes a Task 1 queue 118.1h, a Task 3 queue 118.3h, and a Task 5 queue 118.5h. Processor chips 100b, 100c, 100e, 100f, 100g, and 100i have no active task input queues, although some or all of their queues 118 may be arranged as output queues, receiving results when a task is completed. The arrangement of chips in FIG. 9 will be uses as the basis for specific execution examples discussed in connection with FIGS. 10-14.

FIG. 10 is a transaction flow diagram illustrating an example where a processor deposits a task descriptor into an input queue, and the result is deposited into an output queue for the processor to retrieve. Task execution 1000 begins when a program executed by processor 134a on processor chip 100b results in issuance of a task 3 request 1002 to the task distributor 114b on the processor chip 100b. The task distributor 114b, using a hash table 220 or CAM 252, assigns 1004 the task to the task 3 queue 118.3d on processor chip 100d, which is closer (in terms of network hops) than the task 3 queue 118.3h on processor chip 100h.

After a processor 134c subscribed to the task 3 input queue 118.3d becomes free and determines from the empty flag 765 that there is a descriptor 430b waiting to be dequeued, the processor 134c retrieves 1006 the descriptor from the queue 118.3d. Upon completion of the task, the processor 134c writes 1010 (by packet) the result to an output queue 118h on the processor chip 100b in accordance with the normal return indicator 434. The output queue 118h generates an event signal 1012, waking the processor 134a (if in a low power mode), and causing the processor 134a to retrieve 1014 the results from output queue 118h.

FIG. 11 is a transaction flow diagram illustrating an example where a processor deposits a task descriptor into an input queue, and the result is written back directly to the processor. Task execution 1110 begins when a program executed by processor 134a on processor chip 100b results in issuance of a task 3 request 1102 to the task distributor 114b on the processor chip 100b. The task distributor 114b, using a hash table 220 or CAM 252, assigns 1104 the task to the task 3 queue 118.3d on processor chip 100d, which is closer (in terms of network hops) than the task 3 queue 118.3h on processor chip 100h.

After a processor 134c subscribed to the task 3 input queue 118.3d becomes free and determines from the empty flag 765 that there is a descriptor 430b waiting to be dequeued, the processor 134c retrieves 1106 the descriptor from the queue 118.3d. Upon completion of the task, the processor 134c writes 1110 (by packet) the result directly to operand registers 884 or program memory 874 of the processing element 134a in accordance with the normal return indicator 434.

FIG. 12 is a transaction flow diagram illustrating an example where a processor deposits a task descriptor into an input queue, and execution chains across queues, with the end-result being deposited into an output queue for the processor to retrieve. Chaining may be based on there being multiple task identifiers in the original task descriptor (e.g., FIG. 4B), and/or based on one or more tasks initiating a chain when that task is invoked. The discussion of task execution 1200 in connection with FIGS. 12 and 13A to 13F is based on the former, where the original task descriptor includes multiple task identifiers. Task execution 1200 begins when a program executed by processor 134a on processor chip 100b results in issuance of a task 4 request 1202 to the task distributor 114b on the processor chip 100b. The task distributor 114b, using a hash table 220 or CAM 252, assigns 1204 the task to the task 4 queue 118.4d on processor chip 100d.

After a processor 134e subscribed to the task 4 input queue 118.4d becomes free and determines from the empty flag 765 that there is a descriptor 430b waiting to be dequeued, the processor 134e retrieves 1206 the descriptor from the queue 118.4d. Upon completion of the task, the processor 134e writes 1210 (by packet) the result to a task distributor 114d on the processor chip 100d as a Task 1 request as part of a chained task request. The task distributor 114d send 1212 the Task 1 assignment to the Task 1 input queue 118.1a on processor chip 100a.

After a processor 134a subscribed to the task 1 input queue 118.1a becomes free and determines from the empty flag 765 that there is a descriptor 430b waiting to be dequeued, the processor 134a retrieves 1214 the descriptor from the queue 118.1a. Upon completion of the task, the processor 134a writes 12120 (by packet) the result to an output queue 118h on processor chip 100b, in accordance with the normal return indicator 434. The output queue 118h generates an event signal 1230, waking the processor 134a (if in a low power mode), and causing the processor 134a to retrieve 1234 the results from output queue 118h.

FIGS. 13A to 13F illustrate examples of the content of several of the data transactions in FIG. 12, based on the packet structure discussed in connection with FIGS. 3, 4A and 4B. If a packet payload only contains the address 440 of the task descriptor in memory (as discussed in connection with FIG. 4C) or a packet payload contains a task identifier 432 and the address 450 of a remainder of the task descriptor in memory (as discussed in connection with FIG. 4D), then the descriptors in the transactions illustrated in FIGS. 13A to 13F would reflect the state of the descriptors as stored at the addresses 440 or 450.

FIG. 13A illustrates a packet 1300a used for the task 3 request 1202, as issued by the processing element 134a. The header 1302a contains the address of the task distributor 114b. The packet payload comprises a task descriptor 1330a. The task descriptor 1330a includes a task 4 task identifier 1332a, a task 1 task identifier 1332b, a normal return indicator 1134 corresponding to the address of the output queue 118h, an error reporting address 1336, and the task operands and/or data 1338a. The additional task bit 1333a appended on to the task 4 identifier 1332a is set to indicate there is another task to be performed after task 4. The additional task bit 1333b appended on to the task 1 identifier 1332b is set to indicate there is no other task to be performed after task 1.

FIG. 13B illustrates a packet 1300b used for the queue assignment 1204, as issued by the task distributor 114b. The packet header 1302b contains the address of the task 4 input queue 118.4d. The packet payload comprises a task descriptor 1330b. In comparison to the task descriptor 1330a, the descriptor 1330b omits the task 4 identifier 1332a. FIG. 13C illustrates the task descriptor 1330b as pulled 1206 from the task 4 input queue 118.4d by the task 4 processor 134e.

FIG. 13D illustrates a packet 1300c used for the task 1 request 1210, as issued by the task 4 processor 134e. The packet header 1302c contains the address of the task distributor 114d. The packet payload comprises a task descriptor 1330c. In comparison to the task descriptor 1330b, the descriptor 1330c includes the results 1338b from task 4. The task 4 results may be appended onto the original task operands and data 1338a (as illustrate), mixed with original operands and data 1338a, or the original operands and data 1338a may be omitted.

FIG. 13E illustrates a packet 1300d used for the queue assignment 1212, as issued by the task distributor 114d. The packet header 1302d contains the address of the task 1 input queue 118.1a. The packet payload comprises a task descriptor 1330d. In comparison to the task descriptor 1330c, the descriptor 1330d omits the task 1 identifier 1332b.

FIG. 13F illustrates a packet 1300e sent by the task 1 processor 134a to the output queue 118h in accordance with the normal return indicator 1334. The packet header 1302e contains the address of the output queue 118h. The packet payload may comprise the error reporting address 1336, the task 4 results data 1338b, and the task 1 results data 1338c. The task 1 and the task 4 results may be separate or mixed, or the task 4 1338b results may be omitted. If the original task operands and data 1338a did carry through the chain to the last processor in the chain (task 1 processor 134a in FIG. 12, determining that it is last based on the additional tasks bit 1333b), that last processor may omit the original operands and data 1338a in the final results.

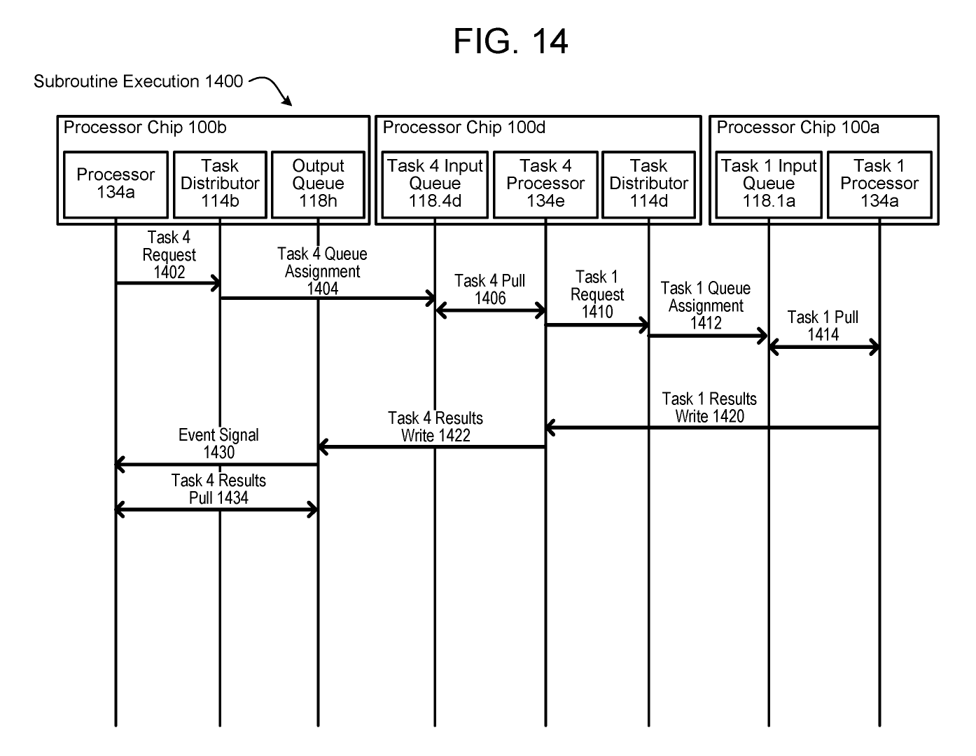

FIG. 14 is a transaction flow diagram illustrating an example where an originating processor 134a deposits a task descriptor into an input queue, and a task-assigned processor deposits a sub-task into another input queue as a subroutine, with the end-result being deposited into an output queue 118h for the originating processor 134a to retrieve. Task execution 1400 begins when a program executed by processor 134a on processor chip 100b results in issuance of a task 4 request 1402 to the task distributor 114b on the processor chip 100b. The task distributor 114b, using a hash table 220 or CAM 252, assigns 1404 the task to the task 4 queue 118.4d on processor chip 100d.

After a processor 134e subscribed to the task 4 input queue 118.4d becomes free and determines from the empty flag 765 that there is a descriptor 430b waiting to be dequeued, the task 4 processor 134e retrieves 1406 the descriptor from the queue 118.4d. In this example, task 4 itself uses task 1 as a subroutine, resulting in the task 4 processor 134e sending 1410 a task 1 request to the task distributor 114d on the processor chip 100d. The task distributor 114d sends 1412 the task 1 assignment to the task 1 input queue 118.1a on processor chip 100a.

After a processor 134a subscribed to the task 1 input queue 118.1a becomes free and determines from the empty flag 765 that there is a descriptor 430b waiting to be dequeued, the processor 134a retrieves 1414 the descriptor from the queue 118.1a. Upon completion of the task, the task 1 processor 134a writes 1420 (by packet) the result directly to the task 4 processor 134e that issued the task 1 request. The task 4 processor 134e thereafter completes task 4, using the task 1 data. Upon completion, the task 4 processor 134e writes 1422 (by packet) the result to an output queue 118h on processor chip 100b, in accordance with the normal return indicator 434. The output queue 118h generates an event signal 1430, waking the originating processor 134a (if in a low power mode), and causing the originating processor 134a to retrieve 1434 the results from output queue 118h.

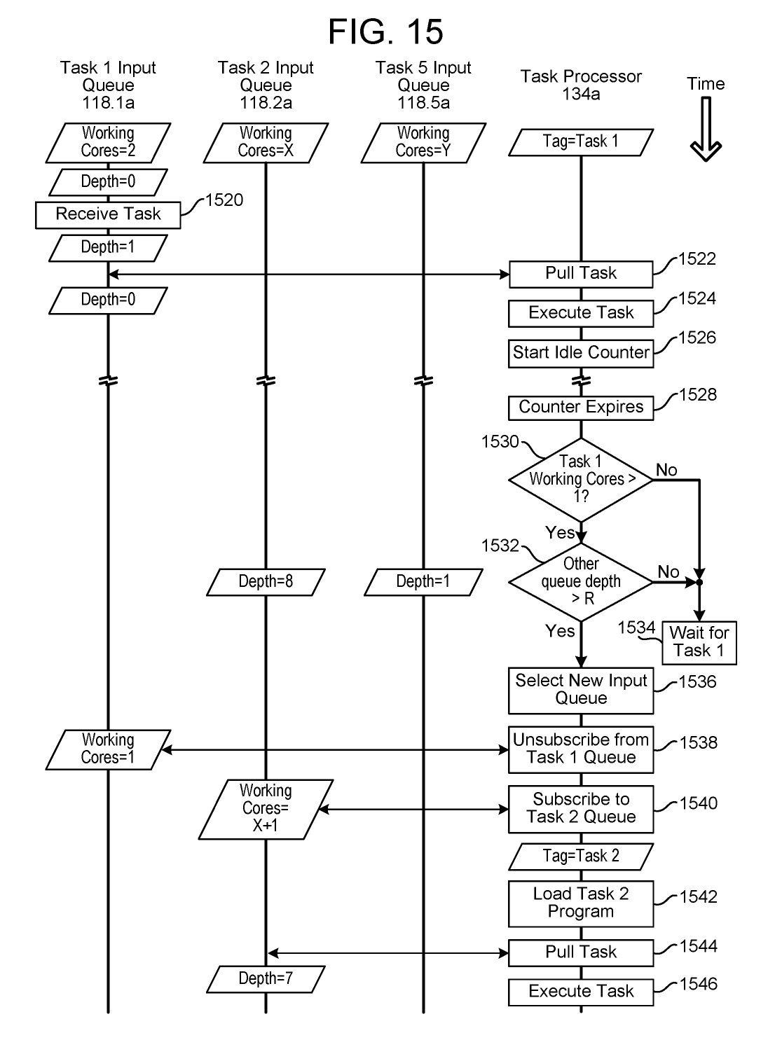

FIG. 15 is a hybrid process-flow transaction-flow diagram illustrating execution of the scheduler program 883 by a task-assigned processor, enabling the processor to autonomously subscribe and unsubscribe from task queues.

Initially, a task processor 134a is subscribed to a task 1 input queue 118.a, which has two subscribed cores (as specified in register 768). The queue depth (from register 764) is initially zero. After the queue 118.1a receives 1520 a task, the task processor 134a dequeues 1522 the task descriptor and executes 1524 the task, returning the results in accordance with the normal return indicator 434. The task processor 134a starts 1426 its idle counter 887 and may enter into a low power mode, waiting for an interrupt from the subscribed task queue indicating that a descriptor is ready to be dequeued. When the counter expires 1528 or reaches a specified value, the task processor 134a runs the scheduler program 883, which determines 1530 whether there is more than one core subscribed to the task 1 queue 118.1a (from register 768), such that the scheduler program 883 is permitted to choose a new input queue. If there is not (1530 “No”) more than one processor subscribe to the task 1 queue 118.1a, the processor 134a continues to wait 1534 for a new task 1 descriptor to appear in the input queue 118.1a. Otherwise, the scheduler program 883 checks other input queues on the device to determine 1532 whether the depth of any of the other queues exceeds a minimum threshold depth “R”. The threshold depth is used to reduce the frequency with which processors unsubscribe and subscribe from and to input queues, since each new subscription results in memory being accessed to retrieve the task program executable code.

If none of the depths of the other input queues exceed “R” (1532 “No”), the processor remains subscribed to the task 1 queue 118.1a. Otherwise, the scheduler 883 selects 1536 a new input queue. For example, the scheduler 883 may select the input queue with the greatest depth, or among input queues tied for the greatest depth. The scheduler 883 unsubscribes 1538 from the task 1 queue 118.1a, decrementing register 768. The scheduler then subscribes 1440 to the task 2 input queue 118.2a which had the largest depth of the task input queues on the device. The scheduler 883 then loads 1542 the task 2 program to the program memory 874 of the processing element 134a, based on the program address in the register 769 of the task 2 queue 118.2a. After the task 2 program is loaded, the task processor 134a resumes normal operations, retrieving 1544 a task 2 descriptor from the task 2 queue 118.2a, and executing that task 1546. The task processor 134a will continue executing that same retrieved program until such time that its idle counter expires again without a task becoming available.

The scheduler program 883 may comprise executable software and/or firmware instructions, may be integrated into each task processor 134 as a sequential logic circuit, or may be a combination of sequential logic with executable instructions. For example, sequential logic included in the task processor 134 may set and start (1526) the idle counter, and determine (1528) that the task processor 134 has been idle for (or longer than) a specified/preset/predetermined duration (e.g., based on the counter expiring or based on a comparison of the count on the counter equaling or exceeding the duration value). In response determining (1528) that the task processor 134 has been idle for (or longer than) the specified duration, the sequential logic may load a remainder of the scheduler program 883 into the instruction registers 882 from the program memory 874 or another memory, based on an address stored in a specified register such as a special purpose register 886.

The disclosed system allows for a simple, relatively easy to understand interface that accommodates chips with a large number of cores and that improves scaling of a system by decoupling logical tasks from the arrangement of physical cores. A programmer writing the main program does not need to know (or care much) about how many cores will be executing assigned tasks. The number of cores can simply increase or decrease, depending on the number of tasks needing execution. Combined with the ability of cores to sleep while waiting for input, this flexible distribution of tasks also helps to reduce power consumption.

Other addressing schemes may also be used, as well as different addressing hierarchies. Whereas a processor core 890 may directly access its own execution registers 882 using address lines and data lines, communications between processing elements through the data transaction interfaces 872 may be via bus-based or packet-based networks. The bus-based networks may comprise address lines and data lines, conveying addresses via the address lines and data via the data lines. In comparison, the packet-based network connections may comprise a single serial data-line, or plural data lines, conveying addresses in packet headers and data in packet bodies via the data line(s).

Aspects of the disclosed system, such as the scheduler 883 and the various executed software and firmware instructions, may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk and/or other media.

The examples discussed herein are meant to be illustrative. They were chosen to explain the principles and application of a task-queue based system computer system, and are not intended to be exhaustive or to limit such a system to the disclosed topologies, hardware structures, logic states, header formats, and descriptor formats. Many modifications and variations that utilize the operating principles of task queuing may be apparent to those of skill in the art. Persons having ordinary skill in the field of computers, microprocessor design, and network architectures should recognize that components and process steps described herein may be interchangeable with other components or steps, or combinations of components or steps, and still achieve the benefits and advantages of task queuing. Moreover, it should be apparent to one skilled in the art, that the disclosure may be practiced without some or all of the specific details and steps disclosed herein.

Different logic and logic elements can be interchanged for the disclosed logic while achieving the same results. For example, a digital comparator that determines whether the depth 764 is equal to zero is functionally identical a NOR gate where the data lines conveying the depth value are input into a NOR gate, the output of which will be asserted when the binary value across the data lines equals zero.

To accommodate the high speeds at which the device 100 will ordinarily operate, it is contemplated that the FIFO queues 118 will be hardware queues, as discussed in connection with FIG. 7. However, although it is contemplated that the queues 118 will be hardware queues, software-controlled queues could be substituted. A mix of hardware queues and software-controlled queues may also be used.

“Writing,” “storing,” and “saving” are used interchangeably. “Enqueuing” includes writing/storing/saving to a queue. When data is written or enqueued to a location by a component (e.g., by a processing element, a task distributor, etc.), the operation may be directed by the component or the component may send the data to be written/enqueued (e.g., sending the data by packet, together with a write instruction). As such, “writing” and “enqueuing” should be understood to encompass “causing” data to be written or enqueued. Similarly, when a component “reads” or “dequeues” from a location, the operation may be directed by the component or the component may send a request (e.g., by packet, by asserting a signal line, etc.) that causes the data to be provided to the component. Queue management (e.g., the updating of the depth, the front pointer, and back pointer) may be performed by the queue itself, such that enqueuing and dequeuing causes queue management to occur, but does not require that the component enqueuing to or dequeuing from the queue to itself be responsible for queue management.

As used in this disclosure, the term “a” or “one” may include one or more items unless specifically stated otherwise. Further, the phrase “based on” is intended to mean “based at least in part on” unless specifically stated otherwise.

What is claimed is:

1. A method comprising:
sending, by a first processing element to a first task distributor, a first task request to perform at least a first task, wherein:
the first task request comprises a first task identifier, a first return indicator, and first data,
the first task identifier identifies the first task,
the first return indicator indicates a location to return a first result, and
the first task is associated with a first plurality of executable instructions;
selecting, by the first task distributor, a first queue associated with the first task;
obtaining, by the first task distributor, a first address of the first queue;
enqueuing, by the first task distributor, the first return indicator and the first data into the first queue in accordance with the first address;
dequeuing, by a second processing element at a first time, the first return indicator and the first data from the first queue;
executing, by the second processing element at a second time, the first plurality of executable instructions using at least a portion of the first data to obtain the first result; and
returning, by the second processing element, the first result in accordance with the first return indicator.

2. The method of claim 1, further comprising:
loading, by the second processing element prior to the dequeuing, the first plurality of executable instructions.

3. The method of claim 1, wherein the location indicated by the first return indicator is a second address of a memory location, and returning the first result comprises writing the first result to the memory location.

4. The method of claim 1, wherein the location indicated by the first return indicator is a second address of a second queue, and returning the first result comprises enqueuing the first result in the second queue, the method further comprising:
dequeuing the first result from the second queue by the first processing element.

5. The method of claim 1, further comprising, prior to the first processing element sending the first task request:
sending, by a third processing element to a second task distributor, a second task request to perform a second task, wherein:
the second task request comprises a second task identifier, the first task identifier, the first return indicator, and second data, and
the second task is associated with a second plurality of executable instructions;
selecting, by the second task distributor, a second queue associated with the second task;
obtaining, by the second task distributor, a second address of the second queue;
enqueuing, by the second task distributor, the first task identifier, the first return indicator and the second data into the second queue in accordance with the second address;
dequeuing, by the first processing element, the first task identifier, the first return indicator, and the second data from the second queue; and
executing, by the first processing element, the second plurality of executable instruction using at least a portion of the second data to obtain a second result,
wherein the first data includes the second result.

6. The method of claim 1, wherein:
selecting the first queue comprises providing the first task identifier as input to a content-addressable memory (CAM), the content-addressable memory associating a plurality of task identifiers, including the first task identifier, with addresses of a plurality of queues, including the first address of the first queue; and
obtaining the first address comprises receiving the first address from the CAM.

7. The method of claim 1, wherein:
selecting the first queue comprises searching a stored table for the first task identifier, the stored table associating a plurality of task identifiers, including the first task identifier, with addresses of a plurality of queues, including the first address of the first queue; and
obtaining the first address comprises determining the first address associated with the first task identifier from the stored table.

8. The method of claim 1, wherein a combination of selecting the first queue and obtaining the first address comprises hashing the first task identifier using a distributed hash function to determine the first address.

9. The method of claim 1, wherein:
the first task identifier, the first return indicator, and the first data are sent by the first processing element to the first task distributor as a first payload of a first data packet,
the first return indicator and the first data are enqueued to the first queue by the first task distributor as a second payload of a second data packet, and
the first result is returned as a third payload of a third data packet.

10. The method of claim 1, further comprising:
waiting, by the second processing element, after the second time, for a second return indicator with second data to be available from the first queue;
determining, by the second processing element at a third time, that the waiting has exceeded a specified duration;
selecting, by the second processing element, a second queue associated with a second task, the second task associated with a second plurality of executable instructions;
loading, by the second processing element after selecting the second queue, the second plurality of instructions;
dequeuing, by the second processing element after loading the second plurality of instructions, a third return indicator and third data from the second queue;
executing, by the second processing element, the second plurality of instructions using at least a portion of the third data to obtain a second result; and
returning, by the second processing element, the second result in accordance with the third return indicator.

11. The method of claim 10, wherein:
the first queue and the second queue are of a plurality of queues, and
selecting the second queue comprises:
determining that at least one of the plurality of queues has a depth exceeding a threshold value; and
selecting the second queue based on the depth of the second queue being a largest or tied for the largest among the plurality of queues.

12. The method of claim 10, further comprising:
determining, by the second processing element, that at least one other processing element is subscribed to the first queue at the third time;
decrementing, after the second queue is selected, a first register associated with the first queue that indicate a first number of processing elements subscribed to the first queue; and
incrementing, after the second queue is selected, a second register associated with the second queue that indicates a second number of processing element subscribed to the second queue.

13. The method of claim 1, wherein the first processing element and the first task distributor are on a first semiconductor chip, the first queue and the second processing element are on a second semiconductor chip, and enqueuing the first return indicator and the first data into the first queue comprises inter-chip communications.

14. A system, comprising:
a first processor;
a first memory storing first executable instructions to be executed by the first processor, wherein:
the first executable instructions configure the first processor to send a first task request to a first task distributor,
the first task request comprises a first task identifier, a first return indicator, and first data,
the first return indicator indicates where to return a first result, and
a first task identified by the first task identifier is associated with execution of second executable instructions;
the first task distributor configured to identify a first queue associated with the first task identifier and enqueue the first return indicator and the first data in the first queue;
the first queue comprising a plurality of storage locations, the first queue configured to provide a data-available indication that indicates there is data enqueued in at least one of the plurality of storage location;
a second processor;
a second memory configured to store the second executable instructions to be executed by the second processor, wherein the second executable instructions configure the second processor to:
dequeue the first return indicator and the first data from the first queue in response to the data-available indication;
process at least a portion of the first data to obtain the first result; and
send the first result in accordance with a the first return indicator.

15. The system of claim 14, wherein:
the first processor and the first task distributor are on a first semiconductor chip, and
the first queue and the second processor are on a second semiconductor chip.

16. The system of claim 14, wherein the first task distributor comprises:
a parser configured to read a predetermined range of bits from the first task request to determine the first task identifier;
a content-addressable memory (CAM) configured to output the first address in response to receiving the first task identifier as input, the CAM containing an associative array that associates a plurality of task identifiers including the first task identifier with addresses of a plurality of queues including a first address of the first queue; and
an assembler configured to assemble and send a packet to the first queue in accordance with the first address, the packet comprising the first return indicator and the first data.

17. The system of claim 14, wherein the first task distributor comprises:
a parser configured to read a predetermined range of bits from the first task request to determine the first task identifier;
an address resolver configured to hash the first task identifier using a distributed hash function to determine the first address; and
an assembler configured to assemble and send a packet to the first queue in accordance with the first address, the packet comprising the first return indicator and the first data.

18. The system of claim 14, the second processor comprising a first timer, the second processor further configured to:
run the first timer and wait for another data-available indication from the first queue after the first result is sent;
determine, based on the first timer, that a duration that the second processor has waited has exceeded a specified duration;
select a second queue associated with a second task, wherein the second task is associated with execution of third executable instructions;
load the third executable instructions into the second memory, after the second queue is selected; and
execute the third executable instructions, to configure the second processor to:
dequeue a second return indicator and second data from the second queue;
processes at least a portion of the second data to obtain a second result; and
send the second result in accordance with the second return indicator.

19. The system of claim 18, wherein the first queue and the second queue are of a plurality of queues, and to select the second queue, the second processor is configured to:
determine that at least one of the plurality of queues has a depth exceeding a threshold value; and
select the second queue based on the depth of the second queue being a largest or tied for the largest among the plurality of queues.

20. The system of claim 18, wherein the second processor is configured to:
obtain a first value from a first register of the first queue indicating a first number of processors subscribed to the first queue;
determine from the first value that at least one other processor is subscribed to the first queue;
decrement first register after the second queue is selected; and
increment a second value in a second register of the second queue after the second queue is selected, the second value indicating a second number of processors subscribed to the second queue.

21. A method comprising:
sending, by a first processing element to a first task distributor, (i) a first task identifier and a first address where a first return indicator and first data are stored in memory, or (ii) a first address where the first task identifier, the first return indicator, and first data are stored in memory, wherein:
the first task identifier identifies a first task associated with execution of a first plurality of executable instructions, and
the first return indicator indicates a location to return a first result;
selecting, by the first task distributor, a first queue associated with the first task;
obtaining, by the first task distributor, a second address of the first queue;
enqueuing, by the first task distributor, the first address or an offset version of the first address into the first queue in accordance with the second address;
dequeuing, by a second processing element, the first address or the offset version of the first address from the first queue;
retrieving, by the second processing element, the first return indicator and the first data from memory based on the first address or the offset version of the first address;
executing, by the second processing element, the first plurality of executable instructions using at least a portion of the first data to obtain the first result; and
returning, by the second processing element, the first result in accordance with the first return indicator.

22. The method of claim 21, further comprising:
loading, by the second processing element prior to the dequeuing, the first plurality of executable instructions.
